(19) United States
(12) Patent Application Publication
(10) Pub. No.: US 2026/0195258 A1
(43) Pub. Date: Jul. 9, 2026

(54) MANAGING ALLOCATION OF STORAGE BLOCKS OF A DISTRIBUTED STORAGE SYSTEM HAVING MULTIPLE STORAGE NODES WITH DISAGGREGATED STORAGE

(71) Applicant: NetApp, Inc., San Jose, CA (US)

(72) Inventors: Manan Patel, San Francisco, CA (US); Anil Paul Thoppil, Pleasanton, CA (US); Ananthan Subramanian, San Ramon, CA (US); Nikhil Mattankot, Pleasanton, CA (US); Jungsook Yang, Mountain View, CA (US)

(73) Assignee: NetApp, Inc., San Jose, CA (US)

(21) Appl. No.: 19/556,719

(22) Filed: Mar. 4, 2026

Related U.S. Application Data
(63) Continuation-in-part of application No. 18/598,713, filed on Mar. 7, 2024.
(60) Provisional application No. 63/767,408, filed on Mar. 5, 2025.

(51) Int. Cl. G06F 12/02

(52) U.S. Cl. CPC G06F 12/023

(57) ABSTRACT

In one embodiment, a method comprises providing a first dynamically extensible file system (DEFS) of a first node and a second DEFS of a second node of a storage cluster having a disaggregated storage space within a storage pod, detecting, with the first DEFS of the first node, blocks and associated physical volume block numbers (PVBNs) to be freed, determining whether the first DEFS owns or does not own an allocation area (AA) having the PVBNs to be freed, and transferring non-owned PVBNs to be freed to a remote free log of the first DEFS when the AA having the PVBNs to be freed is not owned or assigned to the first DEFS.

### CROSS-REFERENCE TO RELATED APPLICATIONS

This application is a continuation-in-part of U.S. patent application Ser. No. 18/598,713, filed on Mar. 7, 2024; and claims priority to U.S. Provisional Patent Application No. 63/767,408, filed on Mar. 5, 2025, which are hereby incorporated by reference in their entirety for all purposes.

### TECHNICAL FIELD

The present disclosure relates to data storage systems and methods for operating the same, and more particularly to data management systems implemented using multiple controllers and multiple physical storage devices. In particular, some embodiments relate to the implementation and use of disaggregated storage space of a storage pod by a distributed storage system having a disaggregated storage architecture to, among other things, efficiently manage allocation and deallocation of storage blocks having different owners including multiple dynamic extensible file systems (DEFSs) (e.g., flexible aggregates), and facilitate data management features at distributed scale.

### BACKGROUND

A storage cluster can include multiple controllers and storage devices. A backend system can provide transaction requests (e.g., read and write requests, or the like) to the controllers. The controllers can interact with the storage devices to service the transaction requests, returning responses to the backend system. The flexibility, ease of management, and performance of such a storage cluster can depend on the physical and logical architecture of the storage cluster. Distributed storage systems generally take the form of a cluster of storage controllers (or nodes in virtual or physical form). As a result of sub-optimal infrastructure architectures, prior scale-out storage solutions do not effectively utilize all three vectors of infrastructure (i.e., compute, network, and storage). For example, as shown in FIG. 12, each node of a distributed storage system may be associated with a dedicated pool of storage space (e.g., a node-level aggregate representing a file system that holds one or more volumes created over one or more RAID groups and which is only accessible from a single node at a time), thereby creating storage silos.

### SUMMARY

Systems and methods are disclosed for communication using message storage.

The disclosed embodiments include a system. The system can include a set of storage devices configured to implement a storage space, a first controller, and a second controller. The first controller can be communicatively connected to the set of storage devices. The first controller can be configured to implement a first domain. The first domain can control a first area of the storage space. The first domain can be configured to perform a first atomic update operation. The first atomic update operation can include writing a first message to the first area of the storage space and enabling access to the first message. The second controller can be communicatively connected to the set of storage devices. The second controller can be configured to implement a second domain. The second domain can control a second area of the storage space. The second domain can be configured to perform a second atomic update operation. The second atomic update operation can include accessing the first message, updating a status of the second domain based on the first message, and enabling access to the status of the second domain. The status of the second domain can be stored in the second area of the storage space.

The disclosed embodiments include an additional system. The system can include a set of storage devices configured to implement a storage space and a first controller communicatively connected to the set of storage devices. The first controller can be configured to implement a first domain. The first domain can control a first area of the storage space. The first domain can be configured to perform a first atomic update operation. The first atomic update operation can include accessing a first message in a second area of the storage space controlled by a second domain, updating a status of the first domain based on the first message, and enabling access to the status of the first domain. The status of the first domain can be stored in the first area of the storage space.

The disclosed embodiments include an additional system. The system can include a set of storage devices configured to implement a storage space and a set of controllers. The set of controllers can include a first controller communicatively connected to the set of storage devices. The first controller can be configured to implement a first domain. The first domain can include an indication storage contained in a first area of the storage space controlled by the first domain. The indication storage can include a reference corresponding to a second domain. The first domain can be configured to perform a first atomic update operation that includes: accessing a message storage included in the second domain to obtain a first message, updating the indication storage to include a reference to an indication that the first message has been processed and enabling access to the indication storage. The message storage can be contained in a second area of the storage space controlled by the second domain. The indication can be contained in the first area of the storage space.

The disclosed embodiments include an additional system. The system can include a set of storage devices configured to implement a storage space and a set of controllers. The set of controllers can include a first controller communicatively connected to the set of storage devices. The first controller can be configured to implement a first domain. The first domain can include an outbound queue contained in a first area of the storage space controlled by the first domain. The outbound queue can include an outbound list root corresponding to a second domain. The first domain can be configured to perform a first atomic update operation. The first update operation can include obtaining a location of an existing initial message for the second domain using the outbound list root, writing a new initial message for the second domain, updating the outbound list root to reference the new initial message, and enabling access to the outbound queue. The new initial message can include a reference to the existing initial message.

The disclosed embodiments further include computer-implemented methods. The computer-implemented methods can include performing the above operations using the above systems.

The disclosed embodiments further include non-transitory, computer-readable media. The non-transitory, computer-readable media can contain instructions for configuring the above systems to perform the above operations.

Systems and methods are described for implementation and use of disaggregated storage of a storage pod by a distributed storage system. According to one embodiment, a disaggregated storage space is created within a storage pod that includes a group of storage devices containing multiple Redundant Array of Independent Disks (RAID) groups by dividing storage space of the group of storage devices into multiple allocation areas (AAs). Each AA includes multiple RAID stripes of a given RAID group. Each node of multiple nodes of a cluster representing a distributed storage system is provided with exclusive write access to one or more portions of the disaggregated storage space by assigning ownership a subset of the multiple AAs to a dynamically extensible file system (DEFS) of the node.

In one embodiment, a method comprises providing a first dynamically extensible file system (DEFS) of a first node and a second DEFS of a second node of a storage cluster having a disaggregated storage space within a storage pod, detecting, with the first DEFS of the first node, blocks and associated physical volume block numbers (PVBNs) to be freed, determining whether the first DEFS owns or does not own an allocation area (AA) having the PVBNs to be freed, and transferring non-owned PVBNs to be freed to a remote free log of the first DEFS when the AA having the PVBNs to be freed is not owned or assigned to the first DEFS.

Other features of embodiments of the present disclosure will be apparent from accompanying drawings and detailed description that follows.

The foregoing general description and the following detailed description are exemplary and explanatory only and are not restrictive of the claims.

### BRIEF DESCRIPTION OF THE DRAWINGS

The accompanying drawings, which are incorporated in and constitute part of this disclosure, together with the description, illustrate and serve to explain the principles of various example embodiments.

FIG. 1 depicts an exemplary data storage system, consistent with disclosed embodiments.

FIG. 2 depicts logical components and relationships of the exemplary data storage system of FIG. 1, consistent with disclosed embodiments.

FIG. 3 depicts an exemplary logical implementation of a domain suitable for use with the exemplary data management system of FIG. 1, consistent with disclosed embodiments.

FIG. 4 depicts a hierarchical reference architecture for enabling access to storage, consistent with disclosed embodiments.

FIG. 5A to 5C depict states of an exemplary persistent messaging architecture using linked lists, consistent with disclosed embodiments.

FIG. 6 depicts an exemplary persistent messaging architecture using storage buffers, consistent with disclosed embodiments.

FIG. 7 depicts a persistent messaging process, consistent with disclosed embodiments.

FIG. 8 is a block diagram illustrating a plurality of nodes interconnected as a cluster in accordance with an embodiment of the present disclosure.

FIG. 9 is a block diagram illustrating a node in accordance with an embodiment of the present disclosure.

FIG. 10 is a block diagram illustrating a storage operating system in accordance with an embodiment of the present disclosure.

FIG. 11 is a block diagram illustrating a tree of blocks representing of an example a file system layout in accordance with an embodiment of the present disclosure.

FIG. 12 is a block diagram illustrating a distributed storage system architecture in which the entirety of a given disk and a given RAID group are owned by an aggregate and the aggregate file system is only visible from one node, thereby resulting in silos of storage space.

FIG. 13A is a block diagram illustrating a distributed storage system architecture 600 that includes multiple storage nodes with each storage node having a DEFS for managing allocation of storage blocks in accordance with an embodiment of the present disclosure.

FIG. 13B is a high-level flow diagram illustrating operations for establishing disaggregated storage within a storage pod in accordance with an embodiment of the present disclosure.

FIG. 14 is a block diagram illustrating a distributed storage system architecture 700 that provides disaggregated storage and remote free block logs for each DEFS in accordance with an embodiment of the present disclosure.

FIG. 15 is a diagram showing a local free log and remote free logs for temporarily storing blocks to be freed in accordance with an embodiment of the present disclosure.

FIG. 16 is a flow diagram of a computer-implemented method 900 illustrating operations for temporarily storing blocks (e.g., PVBNs to be freed) to be freed in remote free logs and then transferring the blocks (e.g., PVBNs to be freed) from a local DEFS to a corresponding remote DEFS that owns an AA associated with the blocks to be freed in accordance with an embodiment of the present disclosure.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations, and other implementations are possible. For example, substitutions, additions, or modifications may be made to the components illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope is defined by the appended claims.

Storage clusters can be organized according to a direct-attached-storage model. A cluster might include controllers connected to storage devices. A storage space can be implemented using a group of the storage devices. A node encapsulating a controller attached to the group of storage devices can be associated with the storage space. Only one domain can be hosted on the storage space, and that domain can only be hosted by the node (or by a backup node that encapsulates another controller connected to the storage devices). The domain controls the entire storage space.

The direct-attached-storage model can be complex and inflexible in practice. Data management system administrators may need to physically divide storage devices into separate collections. Only within each storage space may an administrator be able to flexibly organize content. Changes to the amount of storage in each collection of storage devices may require changing physical connections in the storage cluster. Such changes may be time-consuming and risky. Accordingly, administrators may be obligated to estimate compute and storage requirements for different applications. Misestimation or changes in requirements can result in an inefficient use of resources.

Furthermore, the direct-attached-storage model can be inherently inefficient. A fixed-size storage space implemented by a group of physical devices will typically contain unutilized space. This unutilized space is effectively wasted. Furthermore, duplicate entries cannot be detected when those duplicates appear in different storage spaces.

An architecture that allows multiple nodes to access a single unified storage space could address these flexibility and efficiency concerns. However, such an architecture can create additional problems. When multiple nodes can access the same block in the storage space, the nodes must be prevented from interfering with each other. For example, a first node must be prevented from writing to a block in the storage space while a second node is concurrently reading from that block. However, a mechanism for preventing interference should be flexible enough to permit a transfer of responsibilities between nodes (or domains implemented by nodes).

The disclosed embodiments include a data management system having a physical and logical architecture that addresses the above technical problems. Consistent with disclosed embodiments, the data management system can include nodes that encapsulate the functionality provided by controllers and storage devices configured to implement a unified storage space divided into allocation areas. All controllers can access all storage devices through a switching fabric. Nodes can implement domains, which can host volumes that contain file systems. A domain can control one or more allocation areas. All domains can read from an allocation area. Only the domain controlling an allocation area can write to the allocation area. Domains can be configured to use the storage space for persistent internode communication, as described herein.

The envisioned data management architecture can be simpler to manage than a direct-attached-storage model and can reduce or eliminate fixed partitions of space (and resulting inefficient unutilized space). Each controller can host one or more file systems (e.g., contained in volumes). The amount of storage space controlled by a controller can be increased or decreased. In addition, controllers and storage devices can be added or removed from the cluster. File systems can be rehosted from one controller to another without copying the data comprising the files.

The disclosed embodiments can exploit atomic update operations to ensure that transactions between domains are all-or-nothing. Should a node crash during an update operation, the operations of other domains implemented by other nodes will not be affected. The use of messages stored in the storage space can guarantee delivery of the messages. Such messages can persist in the storage space until the blocks containing the messages are freed. The domain that writes the messages may free the blocks in response to an indication that the messages have been delivered to the domain intended to receive the messages (e.g., copied or processed by the domain intended to receive the messages, or the like). The disclosed embodiments do not require communication locks for message delivery: a transmitting domain and a receiving domain can work in parallel without interfering with each other, and in a wider cluster all domains can send and receive messages to all other domains concurrently without ever having to “take turns” and serialize their work.

As used herein, a reference can include data or instructions that enable an object in a computing system to be located. The data or instructions can enable the logical or physical location of the object. For example, a block number and storage space identifier can enable a block in the storage space to be located. As an additional example, a sector identifier and disk identifier can be used to locate a physical memory location in a magnetic disk. As a further example, a memory address can be used to locate an object in a shared memory (e.g., using remote direct memory access (RDMA) or the like).

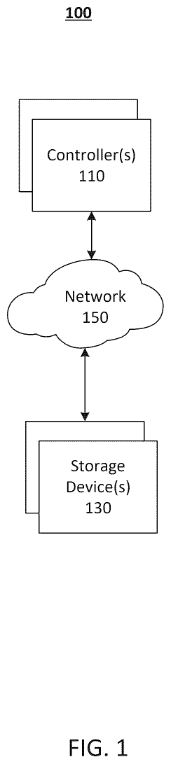

FIG. 1 depicts an exemplary data management system 100, consistent with disclosed embodiments. System 100 can be simpler to configure and administer and can achieve greater storage efficiency than systems in which a controller controls a static collection of physical storage devices. Consistent with disclosed embodiments, the disclosed data management system can enable every controller to physically access every storage device. The physical storage devices can be organized into a single, logical storage space. This architecture enables an administrator to configure and administer a single system, rather than multiple static collections of physical storage devices.

Consistent with disclosed embodiments, controller(s) 110 can be computing devices communicatively connected to storage device(s) 130 through a network 150. The disclosed embodiments are not limited to any particular form factor or device layout for controller(s) 110. In some embodiments, controller(s) 110 can be rack-mounted or self-mounted network appliances. In some embodiments, a controller (e.g., one of controller(s) 110) can include at least one processor, memory, storage, and network interface components. The memory can include DRAM or other suitable volatile memory for storing programs or data. In some embodiments, the memory can further include NVRAM or other nonvolatile memory. The storage can include solid state memory, hard disk drive(s), or other suitable storage media. The network interface components can include ethernet ports, INFINIBAND ports, fiber channel ports, USB ports, or the like. In some embodiments, physical storage and network connectivity resources can be virtualized and visible to data management system administrators.

Consistent with disclosed embodiments, storage device(s) 130 can include one or more storage devices such as hard disk drives, solid state drives, or other storage media. In some embodiments, storage device(s) can be mounted in an enclosure (e.g., a rack, shelf, or other mount). The enclosure can be configured with at least one processor, memory, storage, and network interface components. The memory can include DRAM or other suitable volatile memory for storing programs or data. In some embodiments, the memory can further include NVRAM or other nonvolatile memory. The storage can include solid state memory, hard disk drive(s), or other suitable storage media. The network interface components can include ethernet ports, INFINIBAND ports, fiber channel ports, USB ports, or the like. In some embodiments, the enclosure can configure the storage devices into one or more RAID groups. In some embodiments, the enclosure can be configured to enable controller(s) 110 to access the one or more RAID groups as a single storage space.

Consistent with disclosed embodiments, network 150 can enable controller(s) 110 to access storage device(s) 130. Network 150 can include at least one switch that can route requests from any of controller(s) 110 to storage device(s) 130. As may be appreciated, such a switch can route requests to an enclosure containing the storage device(s), or to one of multiple ports on such an enclosure. Alternatively, the switch can route requests directly to a target storage device. In some embodiments, at least one switch can implement a network topology in which traffic can be flexibly routed through many connections between endpoints (e.g., a switching fabric, or the like). This network topology can be implemented using multiple network switches and/or a fabric switching network appliance.

Network 150 can include connections between at least one switch and controller(s) 110 and between the at least one switch and the storage device(s) 130. Such connections can include ethernet connections (e.g., 10/100 GbE, terabit ethernet, or other suitable ethernet connections). In some embodiments, other connection protocols can be used. In some embodiments, the network can be or include wireless components.

While depicted as a collection of physical devices, the disclosed embodiments are not so limited. In some embodiments, the controllers and/or storage devices can be implemented using capabilities provided by a computing cluster or cloud computing platform (e.g., a virtual machine, container, or the like simulating a physical controller).

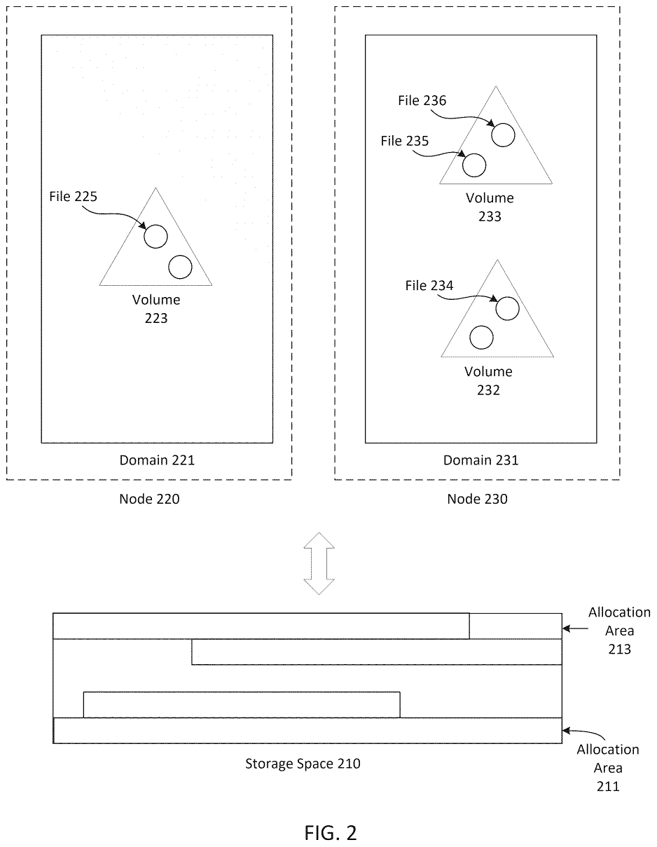

FIG. 2 depicts logical components and relationships of the exemplary data management system 100 of FIG. 1, consistent with disclosed embodiments. Logical components of the system can include a storage space 210 and nodes (e.g., node 220 and node 230). In some embodiments, storage space 210 can be divided into allocation areas (e.g., allocation area 211 and allocation area 213). In some embodiments, nodes can be configured to implement domains (e.g., domain 221 and domain 231). In some embodiments, domains can host volumes (e.g., volume 223, volume 232, and volume 233). In some embodiments, volumes can include files (e.g., file 225, file 234, file 235, and file 236). In some embodiments, files can be implemented using blocks stored in allocation areas of storage space 210.

Consistent with disclosed embodiments, storage space 210 can be implemented using storage device(s) 130. Storage space 210 can be a physical volume block number space (PVBN), in which a block number is associated with a physical storage location in a storage device. In some embodiments, a block can map to an amount of physical memory between 1 kB and 40 kB. As described herein, storage space 210 can be divided into allocation areas. In some embodiments, an allocation area can contain blocks that map to an amount of physical memory between 1 GB and 100 GB.

Consistent with disclosed embodiments, a node can be responsible for processing certain transactions received by the data management system (e.g., transactions from certain addresses, devices, entities, or the like; transactions for certain domains, volumes, or the like). In some embodiments, a node can be implemented by a corresponding controller (e.g., one of controller(s) 110) of data management system. The node can encapsulate the processing, storage, and communication capabilities of the controller. Memory, volatile memory, persistent memory, or the like described as being including or contained in a node can be physically located in (or accessible to) the controller that implements the node.

Consistent with disclosed embodiments, a node can be configured to implement a domain. In some embodiments, a data management system can support the transfer of domains among nodes. For example, the system can maintain a mapping of domains to nodes. The system can update the mapping to transfer responsibility for a domain from one node to another node (e.g., when a node fails). The disclosed embodiments are not limited to any particular implementation of such a mapping. In some embodiments, each node can maintain such a mapping. Transferring a domain across nodes can then include updating the mappings maintained by the individual nodes.

Consistent with disclosed embodiments, a domain can encapsulate allocation areas and volumes. In some embodiments, a domain can be responsible for maintaining the consistency of the encapsulated volumes and allocation areas. A domain can perform update operations to maintain the consistency of the encapsulated volumes and allocation areas.

Consistent with disclosed embodiments, a domain can control allocation area(s). FIG. 2 depicts, as shaded, allocation areas controlled by domain 221 (e.g., allocation area 211) and, as unshaded, allocation areas controlled by domain 231 (e.g., allocation area 213). For example, domain 221 can read and write to the blocks contained in allocation area 211, while domain 231 can only read from blocks contained in allocation area 211. In some embodiments, all allocation areas within the storage space are controlled by a domain. In some embodiments, some allocation areas may remain uncontrolled.

In some embodiments, a domain can transfer control of allocation areas to another domain. For example, domain 221 can transfer allocation area 211 to domain 231. Such functionality can enable domains to acquire needed space (or release unneeded space). Such functionality can also improve the storage efficiency of the system by preventing the fragmentation of unused space across multiple static collections of physical storage devices.

In some embodiments, a domain can allocate or free blocks within an allocation area that it controls. The disclosed embodiments are not limited to a particular method or data structure for allocating and freeing blocks within an allocation area. In some embodiments, a bitmap or similar data structure can track which blocks in the allocation area (or overall storage space) are allocated. The domain can allocate or free a block by writing to the bitmap.

Consistent with disclosed embodiments, a domain can be configured to host volumes. In some embodiments, a volume can be a virtual file system included in a domain. Such an architecture can provide efficiency and administrative benefits. For example, the computational cost of an update operation can be amortized over the traffic associated with the multiple (e.g., tens, hundreds, thousands, or more) volumes in the domain. As an additional example, clients and administrators may interact with volumes using similar operations. For example, duplicating an entire volume (e.g., by an administrator) and duplicating a directory within a volume (e.g., by a client) may involve similar operations. Volumes can be transferred among domains, enabling failure recovery and workload shifting. The ability to transfer volumes can improve the reliability and capacity of the system by supporting recovery from node failures and preventing overloading of individual nodes.

Consistent with disclosed embodiments, a volume can contain files, objects (e.g., S3 objects or the like), or other content. For ease of description, the contents of volumes are described herein with respect to files. Such files can be implemented using blocks stored in allocation areas of storage space 210. In some embodiments, a file included in a volume hosted by a domain can include blocks stored in allocation areas controlled by that domain or other domains. For example, as depicted in FIG. 2, file 225 is included in volume 223, which is hosted by domain 221, and includes blocks in allocation areas controlled by domain 221 (e.g., as indicated with a shaded circle). Similarly, file 234 is included in volume 232, which is hosted by domain 231, and includes blocks in allocation areas controlled by domain 231 (e.g., as indicated with an unshaded circle). However, volume 233 contains files that include blocks stored in allocation areas controlled by domain 221 (e.g., file 235) and by domain 231 (e.g., file 236). As may be appreciated, as part of performing an update operation, domain 231 can determine an updated version of file 235, write the updated version of file 235 to a block in an allocation area controlled by domain 231 (e.g., allocation area 213, or the like), and generate a message instructing domain 221 to free the blocks previously used by file 235.

Consistent with disclosed embodiments, a domain can be configured to perform update operations. Such update operations can update the state of the domain and can be performed repeatedly (e.g., according to a schedule or fixed duration, in response to satisfaction of a condition, or the like). In some embodiments, an update operation can include generating update data using journal data (and optionally data contained in storage space 210). The domain can be configured to write the update data to free blocks in allocation areas of storage space 210 controlled by the domain. In some embodiments, an update operation can include freeing previously used, presently unneeded blocks in storage space 210. A domain can free blocks included in allocation areas it controls, as described herein. In some instances, the domain may attempt to free blocks controlled by other nodes. In such an instance, the domain can provide messages to the domains that control the blocks. The messages can instruct the domains to free the blocks.

In some embodiments, a domain can perform an update operation every 1 to 100 seconds, or another suitable interval. In some embodiments, update operations can be atomic. For example, such an atomic update operation may not affect the functioning of another domain until the update is complete. Accordingly, an atomic update operation performed by a node may appear as a single operation to other nodes. Intermediate stages, states, steps, or processes involved in the performance of the atomic update operation by a first domain may not be visible to other domains.

Consistent with disclosed embodiments, a domain can host a file system. In some embodiments, the file system can be a journaling file system, such as a shadowing journaling file system. As the node implementing the domain services traffic for the domain, transactions (e.g., writes, creates, deletes, or the like) can be accumulated as journal data in a memory (e.g., a non-volatile memory of the controller corresponding to the node that implements the domain) and periodically written to storage (e.g., to a storage device). An update operation can include writing the journal data to the storage. In some embodiments, a domain can be configured to host a write-anywhere-file-layout (e.g., WAFL) system. As described herein, a WAFL system can include metadata and data. An update operation can include generating a consistency point that includes updated metadata and data. The consistency point can define the state of the WAFL system at a point in time.

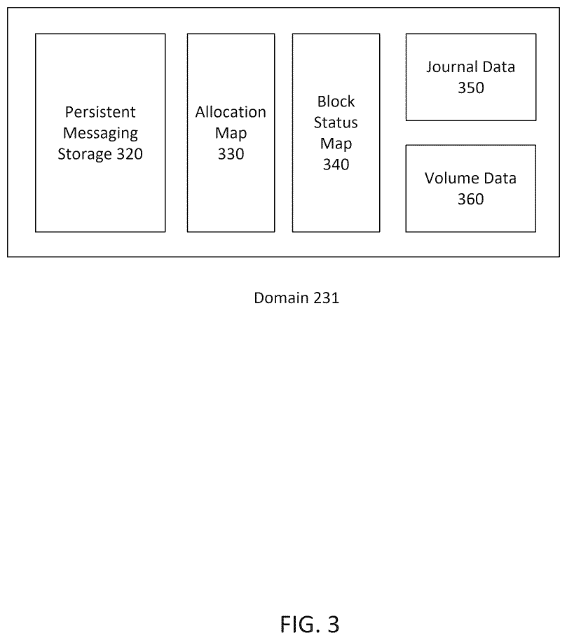

FIG. 3 depicts an exemplary logical implementation of a domain suitable for use with the exemplary data management system 100 of FIG. 1, consistent with disclosed embodiments. While described for convenience with reference to domain 231, other domains can be similarly configured. The depicted logical implementation includes certain components of the domain (e.g., persistent messaging storage 320, allocation map 330, block status map 340, journal data 350, and volume data 360). However, a domain consistent with disclosed embodiments may combine or omit such components or include additional component. Furthermore, the described functions of such components may be performed by other components (or may not be performed), without departing from disclosed embodiments.

Consistent with disclosed embodiments, data management system 100 can implement messaging between domains using persistent messaging storage 320. In some embodiments, persistent messaging storage 320 can be a logical location within a domain. This logical location can be implemented using blocks in allocation areas controlled by the domain. As described herein, each domain can read from all blocks of the storage space (in part, because each controller has access to all storage devices). Accordingly, a domain can write messages to an allocation area controlled by that domain. The domain can then make those messages accessible to other domains through an update operation, as described herein. The other domains can then read the messages and act upon them.

Consistent with disclosed embodiments, data management system 100 can implement domain control of allocation areas using allocation map 330. In some embodiments, allocation map 330 can indicate which domains control which allocation areas. The disclosed embodiments are not limited to a particular implementation of allocation map 330. For example, allocation map 330 can be implemented using a list with entries corresponding to allocation areas or domains, a matrix with entries associating allocation areas with domains, or other suitable data structure(s).

Consistent with disclosed embodiments, data management system 100 can control writing to blocks using block status map 340. In some embodiments, block status map 340 can indicate blocks in use (or free blocks) within storage space 210. In some embodiments, block status map 340 can indicate block status for blocks in allocation areas controlled by domain 231. In some embodiments, block status map 340 can indicate block status for all blocks in storage space 210. The disclosed embodiments are not limited to a particular implementation of block status map 340. In some embodiments, block status map 340 can be implemented as a bit-array. For example, each bit can correspond to a block in storage space 210. One bit value can indicate that the block is in use, while another can indicate that the block is free. The domain can allocate or free a block by writing the appropriate value to the appropriate location in the bit-array.

Consistent with disclosed embodiments, when data management system 100 is implementing a journalling file system, journal data 350 can include transaction data for domain 231. Such transaction data can include write and delete requests directed to volumes hosted by the domain. When performing an update request, the backend system can use the stored data to generate an updated version of file 236 and then write this updated version to allocation areas controlled by domain 231.

Consistent with disclosed embodiments, data management system 100 can associate domains with volumes using volume data 360. In some embodiments, volume data 360 can include information concerning volumes hosted by domain 231. Such information can include the file system of the volume (e.g., a root node for the volume, inodes, data nodes, or the like). In some embodiments, such information can include a RAID file (e.g., volume name, volume size, file system identifier, or the like) or a container file for a volume (e.g., a virtual block address space within the container that can map to the block address space of the storage space, or the like).

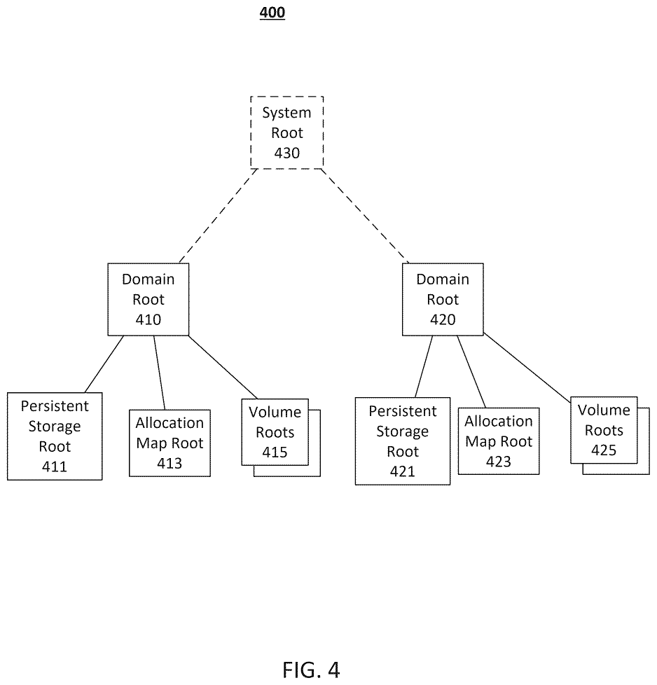

FIG. 4 depicts a hierarchical architecture 400 for enabling access to a persistent messaging storage (e.g., persistent messaging storage 320, or the like), consistent with disclosed embodiments. In some embodiments, hierarchical architecture 400 can enable access data or metadata contained in data management system 100. In some embodiments, architecture 400 can be a tree having leaves and nodes. In some embodiments, the leaves of the tree can be configured to store data (e.g., file data, block status data, allocation ownership data, persistent messages, or the like), while nodes can be configured to store metadata and references to child nodes or leaves.

Consistent with disclosed embodiments, architecture 400 can include a domain root (or superblock) for each domain. For example, architecture 400 can include a domain root 410 for domain 221 and a domain root 420 for domain 231. In some embodiments, domain roots can be stored in predetermined locations (and optionally can be replicated to additional predetermined locations). For example, domain root 410 can be stored in predetermined location(s) in storage space 210. As an additional example, domain root 410 can be stored in predetermined location(s) of a memory or storage of a controller implementing domain 221. In some embodiments, as depicted in FIG. 4, architecture 400 can include a system root 430 for data management system 100. System root 430 can include references to each of the domain roots. A node or domain attempting to perform an update operation, or obtain information from another node or domain, can traverse architecture 400, starting at system root 430, to reach an intended one of the domain roots.

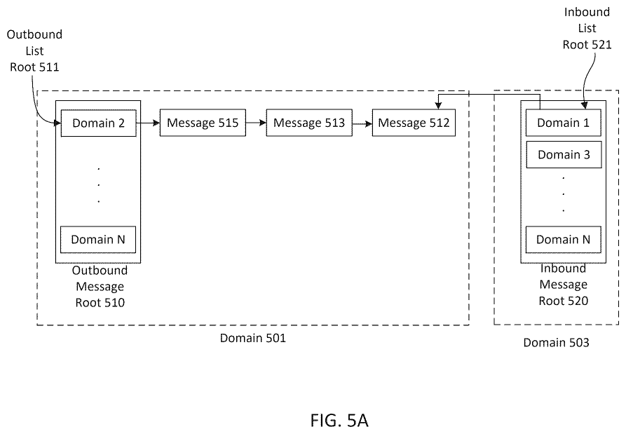

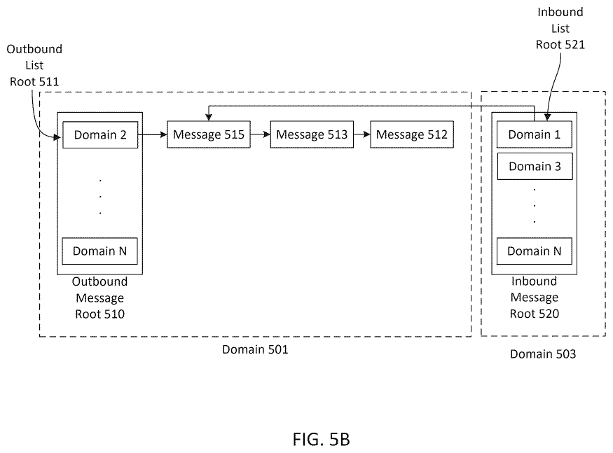

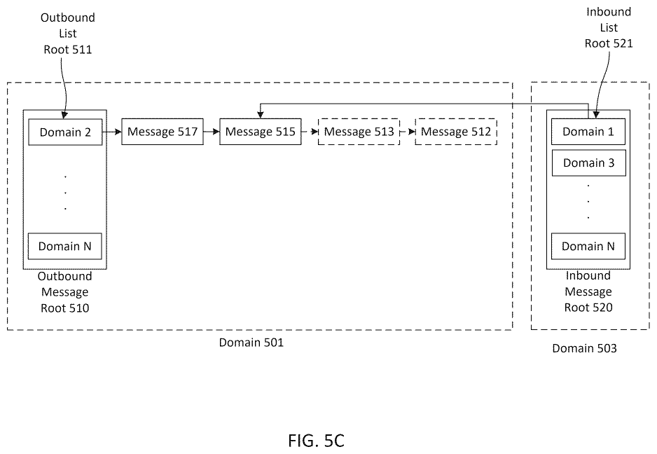

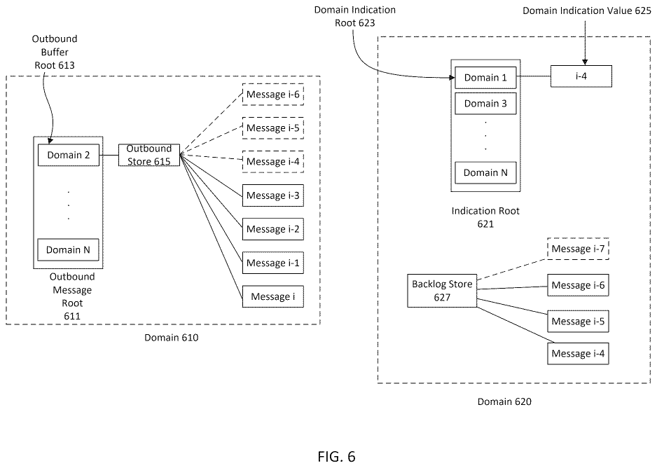

Consistent with disclosed embodiments, a domain root for a domain can include references to other components of the domain. As depicted in FIG. 4, the domain root (e.g., domain root 410) can include references to the persistent messaging storage (e.g., persistent storage root 411), the allocation map (e.g., allocation map root 413), and volumes hosted by the domain (e.g., volume root(s) 415). The disclosed embodiments are not limited to be particular arrangement depicted in FIG. 4. In some embodiments, the domain root can include additional references to additional components of the domain. For example, the domain root can include a reference to a block status map, or to a journal data storage. As an additional example, in place of a single persistent storage root, the domain root can include a reference to multiple sub-components. For example, the domain root can include references to an inbound and an outbound message list, as depicted in FIGS. 5A to 5C, or to a message storage, an indication storage, and a backlog storage, as depicted in FIG. 6. In some embodiments, the arrangement of levels below the domain root can differ from the arrangement depicted in FIG. 4. For example, the domain root can include a reference to an intermediate node, which can in turn include a reference to the persistent storage root, the allocation map root, and the block status map. As an additional example, the domain root can include a volume intermediate node, which can in turn include references to root nodes for each volume hosted by the domain.

Consistent with disclosed embodiments, the update operation can include updating architecture 400. As may be appreciated, architecture 400 can be updated from the bottom up. For example, the domain can generate updated data (e.g., updated file data, block status data, allocation ownership data, persistent messages, or the like) and store the updated data as leaves in new blocks in storage space 210. The domain can then create updated parent nodes for these leaves, the updated parent nodes including references to the new blocks containing the leaves. The domain can store these updated parent nodes in new blocks in storage space 210. The domain can repeat this process until all the parent nodes one level below the domain root have been updated (e.g., the persistent storage space root, the allocation map root, and the volume roots). The domain root can then be updated to reference the parent nodes one level below the domain root.

In embodiments lacking a system root, data stored in the leaves of architecture 400 can be accessed once the domain root is updated. In embodiments including a system root, the data stored in the leaves of architecture 400 can be accessed once the system root is updated. A domain can access the data (e.g., file data, block status data, allocation ownership data, persistent messages, or the like) through the set of references that connect the domain root (or system root) to the leaf node containing the data. For example, a domain can reach persistent storage root 411 using the reference stored in domain root 410. The domain can then reach a leaf containing a persistent message using a reference contained in persistent storage root 411 (and references contained in any intervening nodes).

As may be appreciated, architecture 400 can support the atomicity of the update operation. The domain can be configured to write data in free blocks controlled by the domain: the old data in the prior version of architecture 400 is not overwritten. Until the domain root (or system root) is updated, any other domains attempting to read from architecture 400 (e.g., to read persistent messages) are directed to the prior version of architecture 400. Until the final node is updated (e.g., the domain root or system root), the operation of other domains is unaffected by the creation of the updated version of architecture 400. Once the final node is updated, any other domains attempting to read from architecture 400 are directed to the updated version of architecture 400. Should a node fail during an update, the node can recover using the prior, completed version of architecture 400. Any new blocks written during the update process (e.g., containing updated block status data, allocation map data, or file data) will not be included in the prior version of architecture 400 and will not be marked as allocated. So, the domain will simply treat these blocks as free and overwrite them as needed.

FIGS. 5A to 5C depict an exemplary persistent messaging architecture configured to use linked lists, consistent with disclosed embodiments. In this example, a data management system including N domains is configured according to the exemplary persistent messaging architecture. In some embodiments, the depicted components can be part of hierarchical architectures (e.g., hierarchical architecture 400, or the like) that enable atomic update operations. For each domain, a domain root (or a child node of a domain root) can include a reference to an outbound message root (e.g., outbound message root 510) and to an inbound message root (e.g., inbound message root 520).

For convenience, a domain is referred to as a transmitting domain with respect to the messages the domain writes. A domain is referred to as a receiving domain with respect to the messages the domain reads. As may be appreciated, a domain can operate as both a transmitting and a receiving domain. For example, a first domain can operate as a transmitting domain with respect to messages the domain writes for a second domain, while also operating as a receiving domain with respect to messages the domain reads from the second domain.

In FIGS. 5A to 5C, domain 501 is transmitting messages to domain 503. Domain 501 is therefore a transmitting domain and domain 503 is therefore a receiving domain with respect to the depicted messages. The messages and components depicted as being within domain 501 are stored in allocation areas controlled by domain 501 (or in a controller that implements the node that hosts domain 501). Likewise, the messages and components depicted as being within domain 503 are stored in allocation areas controlled by domain 503 (or in a controller that implements the node that hosts domain 503).

A domain can be configured according to the exemplary persistent messaging architecture to implement messaging using one or more blocks of a storage space (e.g., storage space 210, or the like). New messages can be written to unused blocks and blocks containing messages can be freed after the messages have been processed. The domain can be configured to implement the outbound message root and the inbound message root using one or more blocks of the storage space. The domain can be configured to update the outbound message root and the inbound message root by writing to new blocks of the storage space, rather than overwriting existing, allocated blocks. As described herein, such an approach can support atomic update operations and enable a domain to return to operation following controller failure without losing data.

Consistent with disclosed embodiments, an outbound message root for a transmitting domain can include multiple outbound list roots. In some embodiments, as additional domains are added to (or removed from) the data management system, additional outbound list roots can be added to (or removed from) the outbound message root. In some embodiments, the outbound message root can store at least some of the multiple outbound list roots. In some embodiments, the outbound message root can store references to at least some of the multiple outbound list roots. In some embodiments, an outbound message root can include an outbound list root corresponding to each other receiving domain in the data management system. The transmitting domain can use these outbound list roots in sending messages to the other receiving domains. In some embodiments, the outbound message root for a transmitting domain can include an outbound list root corresponding to the transmitting domain. The transmitting domain can use this outbound list root in sending messages to itself that persist across update operations and are visible to other receiving domains.

Consistent with disclosed embodiments, an outbound list root can store a reference to a message. Such a message can, in turn, store a reference to another message. In this manner, the outbound list root can be the initial link in a linked list of messages from a transmitting domain to a receiving domain.

Consistent with disclosed embodiments, an inbound message root can include multiple list roots. In some embodiments, as additional domains are added to (or removed from) the data management system, additional inbound list roots can be added to (or removed from) the inbound message root. In some embodiments, the inbound message root can include an inbound list root corresponding to each other transmitting domain. In some embodiments, the inbound message root can store at least some of the inbound list roots. In some embodiments, the inbound message root can store references to at least some of the inbound list roots. A receiving domain can use the inbound list root in obtaining messages from the other domains. In some embodiments, the inbound message root for a receiving domain can include an inbound list root corresponding to the receiving domain. The receiving domain can use this inbound list root in sending messages to itself that persist across update operations and are visible to other domains.

Consistent with disclosed embodiments, an inbound list root corresponding to a transmitting domain can store a reference to a message. The referenced message can be the message from the transmitting domain most recently processed by the receiving domain.

FIG. 5A depicts in example including outbound message root 510 for domain 501 (also referred to for convenience as domain 1) and inbound message root 520 for domain 503 (also referred to for convenience as domain 2), consistent with disclosed embodiments. Outbound message root 510 includes outbound list roots (e.g., outbound list root 511) corresponding to other domains (e.g., domains 2 through N). Domain 1 can use these outbound list roots in providing messages to other domains. For example, outbound list root 511 stores a reference to message 515, which in turn stores a reference to a message 513. In this manner, outbound list root 511 is the initial link in a linked list of messages written by domain 1 for domain 2.

Similarly, inbound message root 520 includes inbound list roots (e.g., inbound list root 521) corresponding to other domains (e.g., domains 1 and 3 through N). Domain 2 can use inbound list root 520 in obtaining messages from the other domains. For example, inbound list root 521 stores a reference to message 512, the message from domain 1 most recently processed by domain 2.

Consistent with disclosed embodiments, a receiving domain can determine, as part of an update operation, that a transmitting domain has written messages for the receiving domain. This determination can depend on an outbound list root of the transmitting domain and an inbound list root for the receiving domain. In some embodiments, the receiving domain can determine that the outbound list root and the inbound list root point to different messages. The receiving domain can traverse the linked list of messages starting from the outbound list root until it reaches the message referenced by the inbound list root. In some embodiments, the receiving domain can process the messages in the order traversed (e.g., first-read-first-processed). In some embodiments, the receiving domain can process the messages in the order written by the transmitting domain (e.g., first-read-last-processed). The receiving domain can update the inbound list root to reference the same message as the outbound list root.

FIG. 5B depicts an updated configuration of outbound message root 510 for domain 501 (e.g., domain 1) and inbound message root 520 for domain 503 (domain 2), consistent with disclosed embodiments. In this example, domain 2 has completed an update operation. In this update operation, domain 2 determined that domain 1 had written messages for domain 2, read and processed the messages, and updated inbound list root 521.

Consistent with disclosed embodiments, domain 2 determined that inbound list root 521 and outbound list root 511 referenced different messages: inbound list root 521 referenced message 512 and outbound list root 511 referenced message 515. Domain 2 then traversed the linked list of messages from message 515 until it reached message 512, the message referenced by inbound list root 521. Domain 2 then read and processed message 515 and message 513. Domain 2 then updated inbound list root 521 to reference message 515. As described herein, domain 2 can update inbound list root 521 by writing a new version of inbound list root 521 to the storage space and updating a chain of references from the domain root to the new version of inbound list root 521.

Consistent with disclosed embodiments, a transmitting domain can generate new messages during an update operation. The transmitting domain can write the new message(s) as part of the update operation. Such new message(s) can be written to unused blocks in the storage space. Given an outbound list root that references a message written in a previous update operation, the new messages can be logically inserted between the outbound list root and the previous message. The new messages can form a linked list that connects the outbound list root to the previous message.

Consistent with disclosed embodiments, a transmitting domain can determine that a receiving domain has acknowledged reading and processing a message. In some embodiments, the transmitting domain can identify those messages further along the linked list of messages than the message referenced by the inbound list root. The transmitting domain can then free these messages. In some embodiments, the transmitting domain can also free the blocks containing the messages referenced by the inbound list root. As may be appreciated, in some embodiments the processed messages can be stored in allocation areas controlled by the transmitting domain. The receiving domain does not control these allocation areas and therefore cannot free the blocks containing the processed messages. In this manner, the disclosed persistent messaging architecture can enable the transmitting domain to determine that the receiving domain has processed the messages and free the blocks containing the messages.

The disclosed embodiments are not limited to any particular manner of updating the outbound list root to reference the new messages, or to free blocks. In some embodiments, the transmitting domain can recursively update a hierarchy of references connecting the outbound list root to the domain root (e.g., domain root 410). For example, the transmitting domain can write an updated outbound list root to a new block in storage and then write an updated outbound message root to a new block in the storage space. The updated outbound message root can include a reference to the updated domain root. The transmitting domain can continue this process until the transmitting domain root has been updated. Similarly, the transmitting domain can write an updated block status (e.g., block status map 340) to a new block in the storage space and then recursively update a hierarchy of references connecting the updated block status to the domain root. Once the transmitting domain root is updated, other domains become able to access the updated messages and updated block status through the updated hierarchy of references.

FIG. 5C depicts an updated configuration of outbound message root 510 for domain 501 (e.g., domain 1) and inbound message root 520 for domain 503 (e.g., domain 2), consistent with disclosed embodiments. In this example, domain 1 has completed an update operation. In this update operation, domain 1 has written a new message 517 to domain 2. Consistent with disclosed embodiments, domain 1 has written message 517 to unused blocks in the storage space. Message 517 includes a reference to message 515. Domain 1 has also updated outbound list root 511 to reference message 517. Thus message 517 has been inserted between outbound list root 511 and message 515. In this update operation, domain 1 has also determined, based on inbound list root 521, that message 515, message 513, and message 512 have been received and processed by domain 2. In this example, domain 1 has freed the blocks containing message 513 and message 512.

FIG. 6 depicts an exemplary persistent messaging architecture using buffer files, consistent with disclosed embodiments. In this example, a data management system including N domains is configured to use the exemplary persistent messaging architecture. In some embodiments, the depicted components can be part of hierarchical architectures (e.g., hierarchical architecture 400, or the like) that enable atomic update operations. For each domain, a domain root (or child node(s) of the domain root) can include a reference to an outbound message root, an indication root, and a backlog store. In this example, a domain 610 is depicted as the transmitting domain and a domain 620 is depicted as the receiving domain. Domain 610 can have a domain root (or child node(s) of the domain root) that includes a reference to outbound message root 611. Domain 620 can have a domain root (or child node(s) of the domain root) that includes a reference to indication root 621 and that includes a reference to backlog store 627.

In accordance with the depicted persistent messaging architecture, the transmitting domain (e.g., domain 610) and the receiving domain (e.g., domain 620) can be configured to implement persistent messaging using one or more blocks of the storage space. The outbound message root, indication root, and backlog root can be implemented using one or more blocks of the storage space. Similarly, new messages can be written to unused blocks and blocks containing messages can be freed after the messages have been processed. In some embodiments, a domain can be configured to perform an update operation to enable other domains to access the message root and/or indication root. Such an update operation can include creating a chain of references connecting a domain root for the domain to the message root and/or the indication root. As described herein, such an approach can support atomic update operations and enable a domain to return to operation following controller failure without losing data.

Consistent with disclosed embodiments, an outbound message root can be configured to include outbound buffer roots. In some embodiments, the outbound message root can store at least some of the outbound buffer roots. In some embodiments, the outbound message root can store references to at least some of the outbound buffer roots. In some embodiments, an outbound message root can include an outbound buffer root corresponding to each other receiving domain in the data management system. In some embodiments, an outbound message root can include an outbound buffer root corresponding to the transmitting domain, enabling the transmitting domain to provide messages to itself across update operations that are visible to other domains in the data management system.

Consistent with disclosed embodiments, an outbound buffer root can be configured to reference an outbound store. In some embodiments, the outbound store can include messages. In some embodiments, the outbound store can store the messages. In some embodiments, the outbound store can store references to the messages. During an update operation, the transmitting domain can generate a message. The transmitting domain can include the message in the outbound store (e.g., by storing the message to the outbound store or storing a reference to the message in the outbound store).

In some embodiments, the outbound store can be configured as a circular buffer. The disclosed embodiments are not limited to any particular implementation of a circular buffer. In some embodiments, the outbound store can include a sequence of blocks. A new message (or a reference to a new message) can be written to a next available position in the sequence of blocks. When a message (or reference) is written to the last position in the sequence, the next message (or reference) can be written to the first position in the sequence. In this manner, writes can cycle through the sequence. In some embodiments, the outbound store can store a number indicating a position of the most recently written message (or reference) or indicating the next available position. In some embodiments, the number can be a sequential write number indicating the number of messages written to the circular buffer. As may be appreciated, such a sequential write number can be mapped to a position in the sequence using the number of positions in the sequence and modulo arithmetic. Additionally or alternatively, the number can be a position in the sequence of blocks. In some embodiments, the outbound store can store a number indicating a position of the next message (or reference thereto) to be copied or most recently copied message (or reference thereto). The number can be a sequential write number or a position in the sequence.

In some embodiments, the transmitting domain can be configured to determine during an update operation that messages to a receiving domain have been copied by that receiving domain. The transmitting domain can make this determination based on a domain indication value of the receiving domain (e.g., a domain indication value referenced by a domain indication root corresponding to the transmitting domain). Based on the determination, the transmitting domain can increment the number indicating the position of the next message (or reference thereto) to be copied or most recently copied message (or reference thereto). In some embodiments, the transmitting domain can free any allocated blocks corresponding to the copied messages.

In some embodiments, the capacity of the outbound stores referenced by the outbound buffer roots can differ between transmitting domains or between receiving domains for a particular transmitting domain. In some embodiments, the capacity of the outbound stores can depend on the characteristics of the transmitting domain, such as the amount of processing power or compute available to the transmitting domain or the frequency with which the transmitting domain performs update operations. For example, a transmitting domain with more available processing power or compute (e.g., a transmitting domain capable of generating more messages during an update operation) may have higher capacity files capable of storing more messages. As an additional example, a transmitting domain configured to perform update operations more rapidly than a corresponding receiving domain may have a higher capacity file for storing messages to that receiving domain (e.g., as messages may accumulate between the performance of update operations by the receiving domain).

Consistent with disclosed embodiments, an indication root can be configured to include domain indication roots. In some embodiments, the indication root can store at least some of the domain indication roots. In some embodiments, the indication message root can store references to at least some of the domain indication roots. In some embodiments, an indication root can include a domain indication root corresponding to each other transmitting domain in the data management system. In some embodiments, an indication root can include a domain indication root corresponding to the receiving domain, enabling the receiving domain to signal the copying of messages received from itself.

Consistent with disclosed embodiments, a domain indication root can be configured to reference (or store) a domain indication value. The domain indication value can indicate the message most recently copied for storage in the receiving domain. The disclosed embodiments are not limited to a particular form or format of such an indication. In some embodiments, the indication can be a number, such as the sequential write number for the message or the position for the message in the sequence of blocks in the outbound store of the corresponding outbound buffer root. In some embodiments, the receiving domain can be configured to update the domain indication value during an update operation. The receiving domain can update the domain indication value to match the sequential write number or the position of the most recently copied message (or most recently written message).

Consistent with disclosed embodiments, a backlog store can be configured to include messages copied by a receiving domain from an outbound store of a transmitting domain. In some embodiments, the backlog store can store the copied messages. In some embodiments, the backlog store can store references to the copied messages. In some embodiments, a backlog store can store messages copied from multiple transmitting domains (e.g., all transmitting domains in the data management system) or references thereto. In some embodiments, a backlog store can store messages copied from a single transmitting domain, or references thereto. For example, the receiving domain can be configured with multiple such backlog stores, each transmitting domain corresponding to one of the backlog stores.

In some embodiments, a backlog store can be configured as a circular buffer, similar to the outbound stores referenced by the outbound buffer roots of the outbound message root. The backlog store can similarly include an indication of the most recently copied message and an indication of the most recently processed message. In some embodiments, the backlog store can store a position of the most recently copied message (or reference thereto) and a position of the most recently processed message (or reference thereto).

Consistent with disclosed embodiments, the receiving domain can be configured to copy new messages from the corresponding file of the transmitting domain during an update operation. The receiving domain can read the outbound store of a transmitting domain and obtain the number indicating the next available position or position of the most recently written message (or reference). The receiving domain can compare this number to the indication value referenced by the domain indication root for the transmitting domain. Based on this comparison, the receiving domain can determine that the transmitting domain has written new messages for processing by the receiving domain. The receiving domain can copy the messages included in the outbound store, based on the number indicating the last-copied message and the number indicating the next available position or newly written message. For example, the receiving domain can copy the messages after the last-copied message to the newly written message. In some embodiments, the receiving domain can traverse the outbound store in order (e.g., first written-first copied). In some embodiments, the receiving domain can traverse the outbound store in reverse order (e.g., first written-last copied).

Consistent with disclosed embodiments, the receiving domain can be configured to copy the new messages to the backlog store of the receiving domain. In some embodiments, the backlog store can store references to the messages, which can be stored elsewhere in unused blocks of the storage space. In some embodiments, the receiving domain can be configured to update the number indicating the position of the last copied message (or reference thereto) in the backlog store. As may be appreciated, this number can be independent of the write position number of the copied message.

Consistent with disclosed embodiments, the receiving domain can be configured to process copied messages included in the backlog store. In some embodiments, the receiving domain can be configured to process all messages stored in the backlog store. For example, the receiving domain can process copied messages in order of receipt until the most recently processed message matches the most recently copied message. In some embodiments, a receiving domain can determine whether to process a copied message based on a current status of the receiving domain (e.g., workload, quality of service indicators, etc.) or according to a schedule (e.g., processing a certain number of messages per update, processing messages at a certain time, or the like).

In some embodiments, the backlog store can be configured to track the position in the transmitting domain file of messages copied to the backlog store. For example, messages from multiple transmitting domains can be stored to the same backlog store. Therefore, the position of a message in the backlog store need not match the position of the message in the transmitting domain file. The domain indication value therefore can track the position in the transmitting domain file of the most recently copied message for a transmitting domain.

In some embodiments, a capacity of the backlog store can differ between receiving domains for a data management system. In some embodiments, the capacity of the backlog store can depend on the characteristics of the receiving domain, such as the amount of processing power or compute available to the receiving domain or the frequency with which the receiving domain performs update operations. For example, a receiving domain with more available processing power or compute (e.g., a receiving domain capable of processing more messages during an update operation) may have a lower capacity backlog store capable of storing fewer messages. As an additional example, a receiving domain configured to perform update operations more rapidly than a corresponding transmitting domain(s) may have or require a lower capacity backlog store (e.g., as messages may be processed by the receiving domain during update operations faster than they can accumulate). In some embodiments, the capacity of the backlog store can depend on the number of domains in the data management system. As may be appreciated, the greater the number of domains, the greater the potential number of messages requiring storage.

FIG. 6 further depicts a transmitting domain 610 (domain 1) that includes an outbound message root 611. In this example, outbound message root 611 includes outbound buffer roots (e.g., outbound buffer root 613) corresponding to domain 620 (domain 2) through domain N. In some embodiments, as additional domains are added to (or removed from) the data management system, additional outbound buffer roots can be added to (or removed from) the outbound message root. As described herein, such outbound buffer roots can be stored in or referenced by outbound message root 611. In this example, each outbound buffer root references an outbound store (e.g., outbound store 615). The outbound store in turn references a sequence of messages. In this example, outbound store 615 is configured as a circular buffer, including a sequence of references to messages stored elsewhere in the storage space. Here, the storage space includes references to message i-6 through message i. Of these messages, message i-6 through message i-4 have been copied by the receiving domain (indicated by broken lines). Accordingly, outbound store 615 can be configured to indicate that the last written message is message i and the last copied message is message i-4. Accordingly, in some embodiments, domain 610 may have freed for reuse the blocks containing message i-6 through message i-4, and the blocks in outbound store 615 containing the references to these messages.

FIG. 6 further depicts a receiving domain 620 (domain 2) that includes an indication root 621 and a backlog store 627. Indication root 621 includes domain indication roots (e.g., domain indication root 623 corresponding to domain 610 (domain 1) and domains 3 through N. In some embodiments, as additional domains are added to (or removed from) the data management system, additional domain indication roots can be added to (or removed from) the indication root. As described herein, such domain indication roots can be stored in or referenced by indication root 621. In this example, each domain indication root references a domain indication value (e.g., domain indication value 625). As may be appreciated, in some embodiments, a domain indication root can store a domain indication value. In this example, domain indication value 625 has a value indicating that message i-4 was the last message copied from outbound store 615 to backlog store 627. In some embodiments, this value can be the write position number of message i-4 in outbound store 615, or another suitable indicator. In this example, backlog store 627 includes references to messages copied from transmitting domains. As may be appreciated, in some embodiments backlog store 627 can be configured to store the messages. Here, the copied messages include message i-7 through message i-4. Similar to outbound store 615, backlog store 627 can be implemented as a circular buffer, with a number indicating the last copied message and a number indicating the last processed message. Here, the last copied message is message i-4, while the last processed message is message i-7 (indicated by broken lines). Accordingly, in some embodiments, domain 620 may have freed for reuse the blocks containing message i-7, and the blocks in backlog store 627 containing the references to this message.

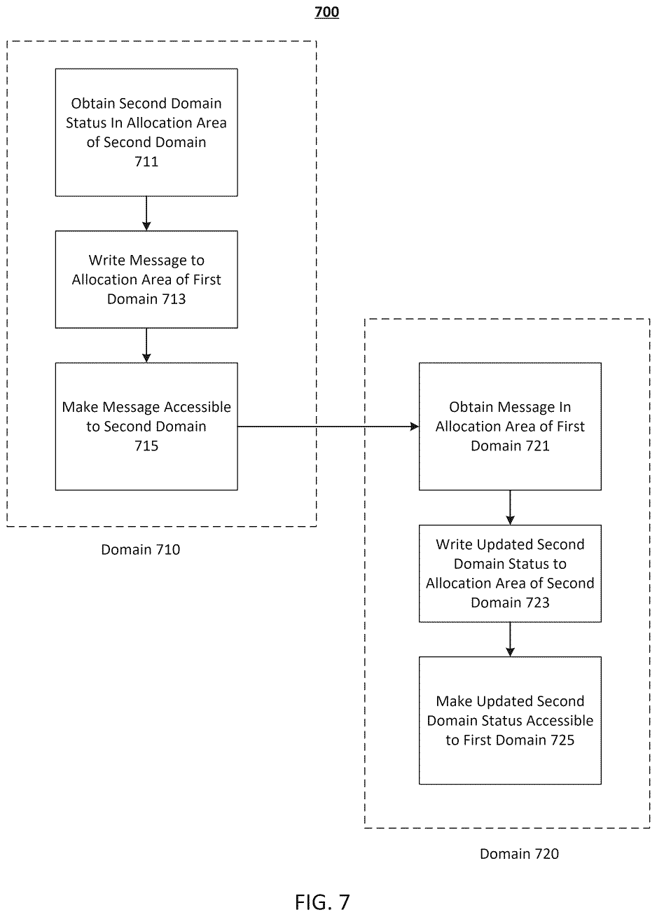

FIG. 7 depicts a persistent messaging process 700, consistent with disclosed embodiments. Process 700 can be performed using a data management system (e.g., data management system 100) that includes controllers and storage devices, or the like. The data management system can be configured with nodes the encapsulate the functionality of the controllers. In some embodiments, the nodes can implement domains, which can in turn host volumes. The storage devices can be configured to implement a storage space. The domains can each own a set of allocation areas in the storage space. In some embodiments, the domains can include persistent messaging storage, an allocation map, and a block status map. The domain can further include journal data. In some embodiments, the domains can be implemented to enable atomic update operations. In some embodiments, a domain can include a hierarchical tree of references. An update operation can include writing updates to the data or metadata of the domain to new blocks in the storage space and integrating the new blocks into a chain of references. The root of the chain of references can be a domain root for the domain. When the domain root for the domain is updated, the updates to the data or metadata can become accessible to the other domains.

In the example depicted in FIG. 7, process 700 concerns communication between domain 710 and a domain 720. For ease of exposition, steps 711 to 715 are depicted as being sequential. However, the disclosed embodiments are not so limiting. In some embodiments or instances, steps 711 to 715 can be performed as part of a single update operation. Furthermore, these steps can be performed in parallel or in another order. Likewise, steps 721 to 725 are depicted as being sequential. However, these steps can be performed as part of a single update operation. Furthermore, these steps can be performed in parallel or in another order.

In step 711 of process 700, domain 710 can read a domain status of domain 720 in an allocation area of domain 720. In some embodiments, the domain status can be contained in a persistent messaging storage of domain 720. In some embodiments, the domain status can indicate that domain 720 has copied or processed a message provided by the domain 710. In some embodiments, domain 710 can use a domain root of domain 720 to read the domain status. In some embodiments, domain 710 can traverse a set of references connecting the domain root to a status indicator stored in the allocation area. In some embodiments, the status indicator can specify a location of the message in domain 710. For example, the status indicator can be a reference to a location of the message in an allocation area controlled by domain 710. For example, an outbound list root can store the status indicator. As an additional example, the status indicator can be a position of the message, prior to copying or processing, in an outbound store of domain 710. For example, a domain indication value can be the status indicator.

In some embodiments, in response to reading the domain status of domain 720, domain 710 can update a status of domain 710. In some embodiments, domain 710 can delete (or mark for deletion) the message. For example, domain 710 can update a block status map to free the blocks containing the message for reuse. In some embodiments, domain 710 can update a persistent messaging storage of domain 710. For example, domain 710 can update a last message processed number in an outbound store.

In step 713 of process 700, domain 710 can write a new message to an allocation area of domain 710. The allocation area can be controlled by domain 710. In some embodiments, the new message can be written to a persistent messaging storage of domain 710. In some embodiments, writing the message to the allocation area includes writing the message to an outbound message list of the persistent messaging storage. In some embodiments, writing the message to the allocation area includes writing the message (or a reference to the message) to an outbound storage. Domain 710 can additionally update a write position number to indicate a location of the message or reference in the outbound store.

In some embodiments, domain 710 can write the new message in response to (and based on the content of) another message. In some instances, domain 710 can read this other message from an allocation area controlled by domain 710. For example, the message can be from domain 710 to itself. Domain 710 can read the message from a persistent messaging storage of domain 710. In some instances, domain 710 can read the message from an allocation area controlled by another domain (e.g., domain 720, or another domain). Domain 710 can read the message from a persistent messaging store of the other domain.

In step 715 of process 700, domain 710 can make the new message accessible to domain 720. In some embodiments, domain 710 can make the new message accessible as part of an update operation. The update operation can be an atomic update operation, as described herein. In some embodiments, domain 710 can include a hierarchical set of references that connect the new message to a root location accessible to domain 720. Such a root location can be or include a system root or a domain root for domain 710. The root location can be a predetermined location in the storage space or in a controller (e.g., a controller memory or storage), or a location provided to other domains in the data management system (e.g., by domain 710, or the like). Knowledge of the root location can enable domain 720 to traverse the hierarchical set of references to access the new message. As described herein, an update operation can include updating the data or metadata contained in the domain. The updated data or metadata can be written to unused blocks in the storage space. The hierarchical set of references can be updated to reference the newly written blocks containing the updated data or metadata. The new references in turn can be written to unused blocks in the storage space. Thus, the hierarchical set of references can be updated from the leaf nodes towards the root. Once a new root node is generated, all of the updates become accessible. Until the new root node is generated (or should the update operation fail) the prior version of domain 710 can remain accessible to the other domains.

In some embodiments, domain 710 can send notifications to other domains. In some embodiments, domain 710 can send the notifications as part of the update operation. Such a notification can indicate that domain 710 has written a new message for the notified domain (e.g., domain 720). In response to the notification, the notified domain can attempt to read the new message. In some embodiments, the notifications can be provided on a best-effort basis. As the data management system may not support reliable delivery of the notification, the data management system may use additional techniques, such as polling, to prompt domains to check for new messages from other domains.

In step 721 of process 700, domain 720 can obtain the new message included in the allocation area of domain 710. In some embodiments, obtaining the new message can include checking domain 710 for the new message and determining that domain 720 has not previously copied or processed the new message. In some embodiments, obtaining the new message can include reading the new message from the persistent messaging storage of domain 710.

Consistent with disclosed embodiments, domain 720 can check for new messages. In some embodiments, domain 720 can poll the persistent messaging storage of domain 710 (e.g., according to a schedule, as part of an update operation, or the like). In some embodiments, domain 720 can check the persistent messaging storage of domain 710 in response to a notification received from domain 710. The notification can indicate that domain 710 has written a new message for domain 720.

Consistent with disclosed embodiments, domain 720 can determine that domain 710 has written a new message based on a domain status of domain 710. In some embodiments, domain 720 can additionally base this determination on a domain status of domain 720. In some embodiments, the domain status of domain 710 can include an outbound reference to blocks containing the new message. The outbound reference can be included in an outbound list root of domain 710, the outbound list root corresponding to domain 720. In some embodiments, the domain status of domain 720 can include an inbound reference to blocks containing the last processed message. The inbound reference can be included in an inbound list root of domain 720, the inbound list root corresponding to domain 710. Domain 720 can determine that the outbound reference differs from the inbound reference. Based on this difference, domain 720 can determine that domain 710 has written new messages to an outbound message list for domain 720.

In some embodiments, the domain status of domain 710 can include a write position number. The write position number can indicate a location of the new message (or reference thereto) in an outbound storage file. In some embodiments, the domain status of domain 720 can include a domain indication value. The domain indication value can be referenced by a domain indication root of domain 720, the domain indication root corresponding to domain 710. The domain indication value can specify a write position number of the last message from domain 710 processed or copied by domain 720. Domain 720 can determine that the write position number differs from the domain indication value. Based on this difference, domain 720 can determine that domain 710 has written new messages to an outbound message list for domain 720.

Consistent with disclosed embodiments, domain 720 can read the new message from the persistent messaging storage of domain 710. In some embodiments, domain 720 can traverse an updated hierarchy of references to reach the persistent messaging storage of domain 710. In some embodiments, domain 720 can traverse this hierarchy of references from a domain root or system root. The disclosed embodiments are not limited to a particular manner of reading the new message from the persistent storage. In some embodiments, domain 720 can read the new message from an outbound message list, as described herein with respect to FIGS. 5A to 5C. In some embodiments, domain 720 can read the new message from an outbound storage, as described herein with respect to FIG. 6.

In step 723 of process 700, domain 720 can write an updated domain status to an association area controlled by domain 720. In some embodiments, domain 720 can write the updated domain status to a persistent messaging storage, allocation map, block status map, or volume data of domain 720. In some embodiments, the updated domain status can be written by domain 720 as part of an update operation.

In some embodiments, writing the update domain status can include updating an outbound list root to reference the new message written to domain 710, as described with respect to FIGS. 5A to 5C. In some embodiments, writing the updated domain status can include copying the message from domain 710, as described with respect to FIG. 6. Domain 720 can copy the message to an allocation area of domain 710. In some embodiments, domain 720 can copy the message to a backlog store of domain 720. Domain 720 can then also update a domain indication value included in the persistent messaging storage of domain 720. The domain indication value can be referenced by a domain indication root corresponding to domain 710. Domain 720 can update the domain indication value based on a write number position of the copied message in domain 710.

In some instances, updating the domain status can include updating an allocation map. For example, domain 710 can determine that allocation areas controlled by domain 710 should be transferred to domain 720, or that allocation areas controlled by domain 720 should be transferred to domain 710. Alternatively or additionally, domain 710 can be instructed (e.g., by an administrator of the data management system) to transfer the allocation areas.

Domain 710 can write a message specifying the transfer of allocation areas to the persistent messaging storage of domain 710 (e.g., to an outbound message list or outbound file of domain 710 that corresponds to domain 720). As part of processing the message, domain 720 can update (e.g., as part of an update operation) an allocation map of domain 720 to reflect the specified transfer of allocation areas. Domain 710 can also update its allocation map in accordance with the message (e.g., either in the same update operation as the message is written, or in a subsequent update operation in response to an updated domain status of domain 720 that indicates that domain 720 processed the message). In this manner, the data management system can support the transfer of allocation areas between domains. In this manner, the area of the storage space controlled by one domain (e.g., domain 710) can be updated to include a portion of the area of the storage space controlled by another domain (e.g., domain 720).

In some instances, updating the domain status can include updating a block status map. For example, domain 710 can host a file system that includes a file. The blocks in the storage space containing the file can be in an allocation area controlled by domain 720. Domain 710 can determine that these blocks can be freed. However, because domain 710 does not control these blocks, domain 710 cannot free these blocks directly. Instead, domain 710 can write a message to persistent messaging storage specifying that the blocks should be freed (e.g., to an outbound message list or outbound file of domain 710 that corresponds to domain 720). As part of processing the message, domain 720 can update (e.g., as part of an update operation) a block status map of domain 720 to release the blocks for reuse.

In some instances, updating the domain status can include updating volume data. For example, domain 710 can host multiple volumes. Domain 710 can determine that a volume hosted by domain 710 should be transferred to another domain. For example, domain 710 can determine that the number, size, frequency, or the like of transactions to the multiple volumes is stressing or overloading the node that implements domain 710. Alternatively or additionally, domain 710 can be instructed (e.g., by an administrator of the data management system) to transfer the volume. Domain 710 can write a message to persistent messaging storage specifying that the volume be transferred (e.g., to an outbound message list or outbound file of domain 710 that corresponds to domain 720). As part of processing the message, domain 720 can update (e.g., as part of an update operation) volume data of domain 720 to transfer the volume. For example, the volume data can be added to a volume root of domain 720.

In some instances, a domain (e.g., domain 710) can determine that another domain (e.g., domain 720) has failed (e.g., through messages sent by the domain, messages sent by a node implementing the domain or watchdog programs running on the same controller as the domain, keep-alive or heartbeat messages, or the like). In some embodiments, in response to the failure of the other domain, the first domain can publish messages to the other domain assuming control of the allocation areas controlled by the other domain and transferring to itself one or more volumes hosted by the other domain. The domain can then begin servicing requests directed to those volumes. When the failed domain recovers, it can read the messages written to it. The failed domain can update its status to reflect the changes in allocation area control and volume hosting. In some instances, the failed domain can then write messages to the domain that acquired the allocation areas and volumes, to begin an orderly process of recovering these resources.

In step 725 of process 700, domain 720 can make the updated domain status accessible to domain 710. In some embodiments, domain 720 can make the updated domain status accessible as part of an update operation. The update operation can be an atomic update operation, as described herein. In some embodiments, domain 720 can include a hierarchical set of references that connect components of the domain (e.g., the persistent messaging storage, allocation map, block status map, volume data, or the like) to a root location accessible to domain 710. Such a root location can be or include a system root or a domain root for domain 720. The root location can be a predetermined location in the storage space or in a controller (e.g., a controller memory or storage), or a location provided to other domains in the data management system (e.g., by domain 720, or the like). Knowledge of the root location can enable domain 710 to traverse the hierarchical set of references to access the updated domain status. As described herein (e.g., with respect to step 715), the updated domain status may not be accessible until a new root node for domain 720 is generated. Until the new root node is generated (or should the update operation fail) the prior version of domain 720 can remain accessible to the other domains.

The disclosed embodiments may further be described using the following clauses:
1. A system comprising: a set of storage devices configured to implement a storage space; a first controller communicatively connected to the set of storage devices, the first controller configured to implement a first domain, wherein: the first domain controls a first area of the storage space; and the first domain is configured to perform a first atomic update operation that includes: writing a first message to the first area of the storage space; and enabling access to the first message; and a second controller communicatively connected to the set of storage devices, the second controller configured to implement a second domain, wherein: the second domain controls a second area of the storage space; and the second domain is configured to perform a second atomic update operation that includes: accessing the first message; updating a status of the second domain based on the first message, the status of the second domain stored in the second area of the storage space; and enabling access to the status of the second domain.
2. The system of clause 1, wherein: the first domain hosts a first file system; and the first message specifies that the second domain host the first file system.
3. The system of clause 1, wherein: the first domain hosts a first file system associated with first blocks included in the second area; and the first message specifies that the second domain release the first blocks for reuse.
4. The system of clause 1, wherein: the first message specifies that the second domain update the second area to include a portion of the first area.
5. The system of any one of clauses 1 to 4, wherein: enabling access to the first message includes creating a set of references connecting the first message to a root node of the first domain.
6. The system of any one of clauses 1 to 5, wherein: the first atomic update operation comprises a consistency point generation operation.
7. The system of any one of clauses 1 to 6, wherein: the updated status of the second domain indicates that the second domain has copied or processed the first message.
8. The system of any one of clauses 1 to 7, wherein: writing the first message to the first area includes writing the first message to an outbound message list of the first domain; and updating the status of the second domain comprises updating a referenced location in the outbound message list.
9. The system of any one of clauses 1 to 7, wherein: the first area includes an outbound store configured to reference a sequence of messages for the second domain; writing the first message to the first area includes updating the outbound store to include a reference the first message in the sequence; and updating the status of the second domain comprises updating a value indicating a position in the sequence.
10. The system of clause 9, wherein: the outbound store is implemented using a circular buffer.
11. The system of any one of clauses 1 to 10, wherein: the second atomic update operation further includes copying the first message to a backlog store of the second domain.
12. The system of clause 11, wherein: the second atomic update operation further includes updating an allocation map or updating volume data for the second domain based on messages stored in the backlog store.
13. The system of clause 11, wherein: a capacity of the backlog store of the second domain depends on a status or characteristic of the second node.
14. The system of any one of clauses 1 to 13, wherein: the accessing the first message includes polling the first area; or the first atomic update operation further includes sending a notification to the second domain and the second atomic update operation includes receiving the notification and the first message is accessed in response to receipt of the notification.
15. The system of any one of clauses 1 to 14, wherein: the first atomic update operation further includes: accessing a second message from the first area and the first message is written based on the second message; or accessing a third message from the second area and the first message is written based on the third message.
16. A system comprising: a set of storage devices configured to implement a storage space; a first controller communicatively connected to the set of storage devices, the first controller configured to implement a first domain, wherein: the first domain controls a first area of the storage space; and the first domain is configured to perform a first atomic update operation that includes: accessing a first message in a second area of the storage space controlled by a second domain; updating a status of the first domain based on the first message, the status of the first domain stored in the first area of the storage space; and enabling access to the status of the first domain.
17. The system of clause 16, wherein: the second domain hosts a first file system; the first message specifies that the first domain host the first file system; and the first atomic update operation further includes copying the first file system into the first area.
18. The system of clause 16, wherein: the second domain hosts a first file system associated with first blocks included in the first area; the first message specifies that the first domain release the first blocks for reuse; and the first atomic update operation further includes updating a first block status map to enable reuse of the first blocks.
19. The system of clause 16, wherein: the first message specifies that the first domain update the first area to include a portion of the second area; and the first atomic update operation further includes updating an allocation map of the first domain to indicate that the first domain controls the portion.
20. The system of any one of clauses 16 to 19, wherein: enabling access to the status of the first domain includes creating a set of references connecting the status of the first domain to a root node of the first domain.
21. The system of any one of clauses 16 to 20, wherein: the first atomic update operation comprises a consistency point generation operation.
22. The system of any one of clauses 16 to 21, wherein: the first atomic update operation further includes: determining a third domain has failed; updating an allocation map for the first domain to assign allocation areas controlled by the third domain to the first domain; updating a volume information for the first controller to assign a volume hosted by the third controller to the first domain; and enabling access to the updated allocation map and the updated volume information.
23. A system comprising: a set of storage devices configured to implement a storage space; and a set of controllers, the set of controllers including a first controller communicatively connected to the set of storage devices, the first controller configured to implement a first domain, wherein: the first domain includes an indication storage contained in a first area of the storage space controlled by the first domain, the indication storage including a reference corresponding to a second domain; and the first domain is configured to perform a first atomic update operation that includes: accessing a message storage included in the second domain to obtain a first message, the message storage contained in a second area of the storage space controlled by the second domain; updating the indication storage to include a reference to an indication that the first message has been processed, the indication contained in the first area of the storage space; and enabling access to the indication storage.
24. The system of clause 23, wherein: the second domain hosts a first file system; the first message specifies that the first domain host the first file system; and the first atomic update operation further includes copying the first file system into the first area.
25. The system of clause 23, wherein: the second domain hosts a first file system associated with first blocks included in the first area; the first message specifies that the first domain release the first blocks for reuse; and the first atomic update operation further includes updating a first block status map to enable reuse of the first blocks.
26. The system of clause 23, wherein: the first message specifies that the first domain update the first area to include a portion of the second area; and the first atomic update operation further includes updating an allocation map of the first domain to indicate that the first domain controls the portion.
27. The system of any one of clauses 23 to 26, wherein: accessing the message storage to obtain the first message includes traversing a domain root and an outbound store configured to reference each of a sequence of messages for the second domain, the sequence of messages including the first message; and the indication specifies a last processed position in the sequence.
28. The system of clause 27, wherein: the outbound store is implemented using a circular buffer.
29. The system of any one of clauses 23 to 28, wherein: the outbound store contains a sequence start position and a sequence end position.
30. The system of any one of clauses 23 to 29, wherein: the first atomic update operation further includes copying the first message to the first area of the storage space.
31. The system of any one of clauses 23 to 30, wherein: the first domain further includes a backlog store contained in the first area of the storage space, the backlog store including references to unprocessed messages copied from other domains.
32. The system of clause 31, wherein: the first atomic update operation further includes updating the backlog store to include a reference to a copy of the first message.
33. The system of any one of clauses 31 to 32, wherein: a capacity of the backlog store depends on a status or characteristic of the first controller.
34. The system of any one of clauses 31 to 33, wherein: the backlog store is implemented using a circular buffer.
35. The system of any one of clauses 23 to 34, wherein: enabling access to the indication storage includes creating a set of references connecting the indication storage to a root node of the first domain.
36. The system of any one of clauses 23 to 35, wherein: the first atomic update operation comprises a consistency point generation operation.
37. A system comprising: a set of storage devices configured to implement a storage space; and a set of controllers, the set of controllers including a first controller communicatively connected to the set of storage devices, the first controller configured to implement a first domain, wherein: the first domain includes an outbound queue contained in a first area of the storage space controlled by the first domain, the outbound queue including an outbound list root corresponding to a second domain; and the first domain is configured to perform a first atomic update operation that includes: obtaining a location of an existing initial message for the second domain using the outbound list root; writing a new initial message for the second domain, the new initial message including a reference to the existing initial message; updating the outbound list root to reference the new initial message; and enabling access to the outbound queue.
38. The system of clause 37, wherein: the first controller hosts a first file system; and the first message specifies that the second domain host the first file system.
39. The system of clause 37, wherein: the first domain hosts a first file system associated with first blocks included in a second area of the storage space controlled by the second domain; and the first message specifies that the second domain release the first blocks for reuse.
40. The system of clause 37, wherein: the first message specifies that the second domain update a second area of the storage space controlled by the second domain to include a portion of the first area.
41. The system of any one of clauses 37 to 40, the system further comprising: a second controller of the set of controllers, the second controller communicatively connected to the set of storage devices, the second controller configured to implement the second domain, wherein: the second domain includes an inbound queue contained in a second area of the storage space controlled by the second domain, the inbound queue including an inbound list root corresponding to the first domain; and the second domain is configured to perform a second atomic update operation that includes: reading the inbound list root; comparing the inbound list root to the outbound list root; based on the comparison, updating the second domain based on the new initial message; updating the inbound list root based on the outbound list root; and enabling access to the inbound queue.
42. The system of clause 41, wherein: the first domain is configured to perform a third atomic update operation that includes: reading the inbound list root; comparing the outbound list root to the inbound list root; and based on the comparison, enabling reuse of a portion of the first area containing the existing initial message.
43. The system of any one of clauses 41 to 42, wherein: the second atomic update operation further includes: traversing a sequence of messages from a message referenced by the outbound list root to a message referenced by the inbound list root; and processing the messages in reverse sequence order.
44. The system of any one of clauses 37 to 43, wherein: enabling access to the outbound queue includes creating a set of references connecting the outbound queue to a root node of the first domain.
45. The system of any one of clauses 37 to 44, wherein: the first atomic update operation comprises a consistency point generation operation.
46. At least one non-transitory, computer-readable medium containing instructions for configuring the system of any one of clauses 1 to 43 to perform the operation(s) recited therein.
47. A computer-implemented method including the performance of the operation(s) of any one of clauses 1 to 43 using the system recited therein.

As used herein, unless specifically stated otherwise, the term “or” encompasses all possible combinations, except where infeasible. For example, if it is stated that a component may include A or B, then, unless specifically stated otherwise or infeasible, the component may include A, or B, or A and B. As a second example, if it is stated that a component may include A, B, or C, then, unless specifically stated otherwise or infeasible, the component may include A, or B, or C, or A and B, or A and C, or B and C, or A and B and C.

Systems and methods are described for implementation and use of disaggregated storage space of a storage pod by a distributed storage system having a disaggregated storage architecture to, among other things, efficiently manage allocation and deallocation of storage blocks that are part of allocation areas owned by different dynamic extensible file systems (DEFSs) (e.g., flexible aggregates), and facilitate data management features at distributed scale. Each DEFS has a local free log for physical volume block numbers (PVBNs) owned by the local DEFS and a remote free log for each remote DEFS to temporarily store PVBNs to be freed that are owned by remote DEFS. Each DEFS has the ability to determine if PVBNs to be freed are owned by the DEFS or owned by a remote DEFS of a storage cluster.

As compared to existing scale out storage solution architectures, various examples described herein facilitate various advantages, including, but not limited to, one or more of the following:
Simplified management
No silos of storage space
Independent file system operation on each node of a cluster
Independent scaling of performance and capacity (e.g., the ability to independently add nodes and/or disks on demand)
Reduced internode (or “East-West”) communications/traffic
No additional redirection in the Input/Output (I/O) path
No additional write amplification
Integration with existing storage operating systems (e.g., the ONTAP data management software available from NetApp, Inc. of San Jose, CA).
Distributed disk operations
The ability to use all disks associated with a distributed storage system in a more uniform manner

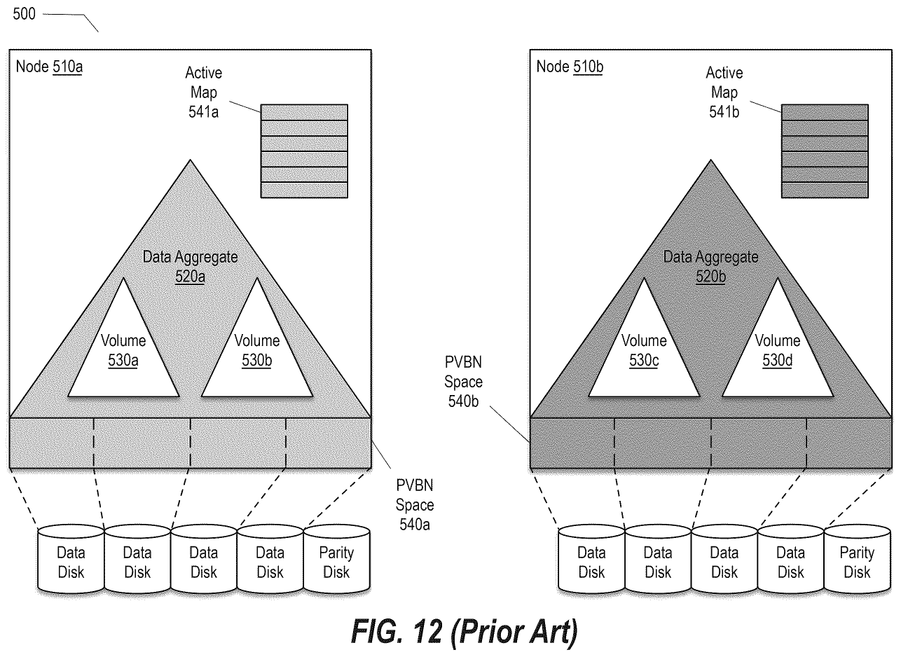

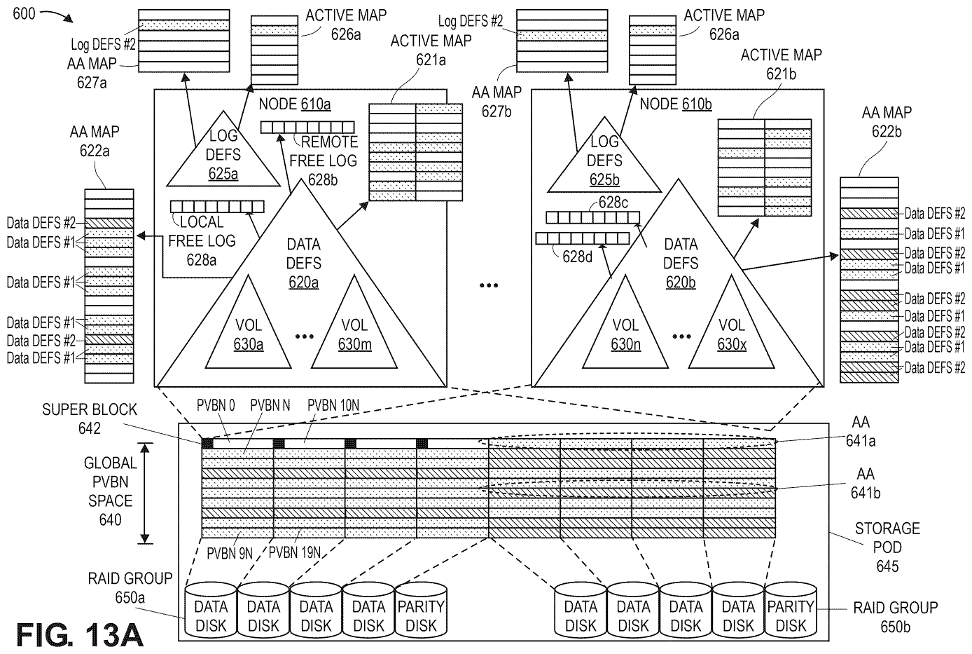

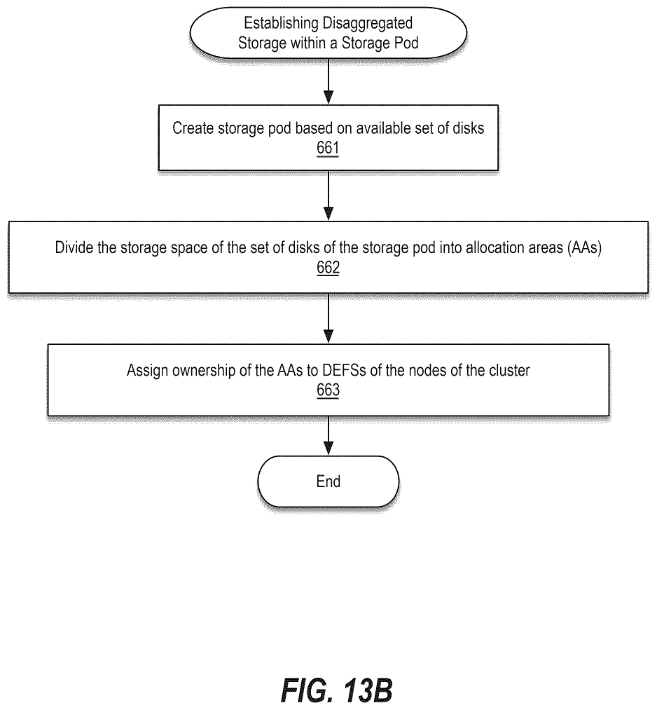

In various examples described herein, storage device (or “disk”, which may be used interchangeably throughout this specification) space may be used more fluidly across all the individual storage systems (e.g., nodes) of a distributed storage system (e.g., a cluster of nodes working together), thereby eliminating silos of storage; and processing resource (e.g., central processing unit (CPU)) load may be distributed across the cluster. The proposed architecture seeks to prevent a given disk from being tied to any single node of the cluster by introducing a new construct referred to herein as a “dynamically extensible file system,” examples of which are described further below with reference to FIG. 13. In contrast to the entirety of a given storage device (e.g., a disk) being owned by a node-level aggregate and the aggregate file system being visible from only one node of a cluster as shown and described with reference to FIG. 12, the use of dynamically extensible file systems facilitates visibility by all nodes in the cluster to the entirety of a global physical volume block number (PVBN) space of the disks associated with a single “storage pod” (another new construct introduced herein) that may be shared by all of the nodes of the cluster with space from the global PVBN space being used on demand.

In one embodiment, each node of a cluster has access to do read and write to all the disks in a storage pod associated with a cluster. Given all the nodes have access to the same disks, a RAID subsystem or layer can now assimilate the same RAID tree from the same set of disks and present the global PVBN space to the file system (e.g., a write anywhere file system, such as the write anywhere file layout (WAFL) file system available from NetApp, Inc. of San Jose, CA). Using the global PVBN space, each node of the cluster can create an independent file system that it needs. As those skilled in the art will appreciate, it would be dangerous for each node to allocate from the same global PVBN space independently and without limitation. As such, examples of the proposed architecture restrict each dynamically extensible file system to use (consume) space only from the blocks assigned to it. As such, when performing writes, each dynamically extensible file system stays in its own lane without the need for complex access control mechanisms, such as locks.

As described further below, in some examples, the association of blocks to a dynamically extensible file system may be in large chunks of one or more gigabytes (GB), which are referred to herein as “allocation areas” (AAs) that each include multiple RAID stripes. The use of large, multi-GB chunks, as the unit of space allocation/assignment to dynamically extensible file systems facilitates ease of management (e.g., by way of reducing the frequency of ownership transfers among dynamically extensible file systems) of these AAs. The assignment of AAs to individual dynamically extensible file systems, which in turn are owned by nodes, additionally helps each node do its write allocation independently since, by definition an entire RAID stripe is owned by a single dynamically extensible file system. In some embodiments, dynamically extensible file systems also minimize or at least significantly reduce the need for internode communications. For example, dynamically extensible file systems can limit their coordination across nodes to situations in which space balancing is to be performed (e.g., responsive to a node running low on free storage space relative to the other nodes), which is not a frequent operation. Responsive to a space balancing trigger event, a given dynamically extensible file system (or the node owning given dynamically extensible file system on behalf of the given dynamically extensible file system) may request space be reassigned to it from one or more other dynamically extensible file systems. The combination of visibility into the entire global PVBN space and the use of dynamically extensible file systems and their association with a given portion of the disaggregated storage of a storage pod to which a given dynamically extensible file system has exclusive write access enables each node to run independently most of the time.

In the following description, numerous specific details are set forth in order to provide a thorough understanding of embodiments of the present disclosure. It will be apparent, however, to one skilled in the art that embodiments of the present disclosure may be practiced without some of these specific details. In other instances, well-known structures and devices are shown in block diagram form.

### Terminology

Brief definitions of terms used throughout this application are given below.

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The phrases “in an embodiment,” “according to one embodiment,” and the like generally mean the particular feature, structure, or characteristic following the phrase is included in at least one embodiment of the present disclosure and may be included in more than one embodiment of the present disclosure. Importantly, such phrases do not necessarily refer to the same embodiment.

As used herein a “cloud” or “cloud environment” broadly and generally refers to a platform through which cloud computing may be delivered via a public network (e.g., the Internet) and/or a private network. The National Institute of Standards and Technology (NIST) defines cloud computing as “a model for enabling ubiquitous, convenient, on-demand network access to a shared pool of configurable computing resources (e.g., networks, servers, storage, applications, and services) that can be rapidly provisioned and released with minimal management effort or service provider interaction.” P. Mell, T. Grance, The NIST Definition of Cloud Computing, National Institute of Standards and Technology, USA, 2011. The infrastructure of a cloud may be deployed in accordance with various deployment models, including private cloud, community cloud, public cloud, and hybrid cloud. In the private cloud deployment model, the cloud infrastructure is provisioned for exclusive use by a single organization comprising multiple consumers (e.g., business units), may be owned, managed, and operated by the organization, a third party, or some combination of them, and may exist on or off premises. In the community cloud deployment model, the cloud infrastructure is provisioned for exclusive use by a specific community of consumers from organizations that have shared concerns (e.g., mission, security requirements, policy, and compliance considerations), may be owned, managed, and operated by one or more of the organizations in the community, a third party, or some combination of them, and may exist on or off premises. In the public cloud deployment model, the cloud infrastructure is provisioned for open use by the general public, may be owned, managed, and operated by a cloud provider or hyperscaler (e.g., a business, academic, or government organization, or some combination of them), and exists on the premises of the cloud provider. The cloud service provider may offer a cloud-based platform, infrastructure, application, or storage services as-a-service, in accordance with a number of service models, including Software-as-a-Service (SaaS), Platform-as-a-Service (PaaS), and/or Infrastructure-as-a-Service (IaaS). In the hybrid cloud deployment model, the cloud infrastructure is a composition of two or more distinct cloud infrastructures (private, community, or public) that remain unique entities, but are bound together by standardized or proprietary technology that enables data and application portability (e.g., cloud bursting for load balancing between clouds).

As used herein, a “storage system” or “storage appliance” generally refers to a type of computing appliance or node, in virtual or physical form, that provides data to, or manages data for, other computing devices or clients (e.g., applications). The storage system may be part of a cluster of multiple nodes representing a distributed storage system. In various examples described herein, a storage system may be run (e.g., on a VM or as a containerized instance, as the case may be) within a public cloud provider.

As used herein, the term “storage operating system” generally refers to computer-executable code operable on a computer to perform a storage function that manages data access and may, in the case of a storage system (e.g., a node), implement data access semantics of a general purpose operating system. The storage operating system can also be implemented as a microkernel, an application program operating over a general-purpose operating system, such as UNIX or Windows NT, or as a general-purpose operating system with configurable functionality, which is configured for storage applications as described herein. In some embodiments, a light-weight data adaptor may be deployed on one or more server or compute nodes added to a cluster to allow compute-intensive data services to be performed without adversely impacting performance of storage operations being performed by other nodes of the cluster. The light-weight data adaptor may be created based on a storage operating system but, since the server node will not participate in handling storage operations on behalf of clients, the light-weight data adaptor may exclude various subsystems/modules that are used solely for serving storage requests and that are unnecessary for performance of data services. In this manner, compute intensive data services may be handled within the cluster by one of more dedicated compute nodes.

As used herein, a “cloud volume” generally refers to persistent storage that is accessible to a virtual storage system by virtue of the persistent storage being associated with a compute instance in which the virtual storage system is running. A cloud volume may represent a hard-disk drive (HDD) or a solid-state drive (SSD) from a pool of storage devices within a cloud environment that is connected to the compute instance through Ethernet or fibre channel (FC) switches as is the case for network-attached storage (NAS) or a storage area network (SAN). Non-limiting examples of cloud volumes include various types of SSD volumes (e.g., AWS Elastic Block Store (EBS) gp2, gp3, io1, and io2 volumes for EC2 instances) and various types of HDD volumes (e.g., AWS EBS st1 and sc1 volumes for EC2 instances).

As used herein a “consistency point” or “CP” generally refers to the act of writing data to disk and updating active file system pointers. In various examples, when a file system of a storage system receives a write request, it commits the data to permanent storage before the request is confirmed to the writer. Otherwise, if the storage system were to experience a failure with data only in volatile memory, that data would be lost, and underlying file structures could become corrupted. Physical storage appliances commonly use battery-backed high-speed non-volatile random access memory (NVRAM) as a journaling storage media to journal writes and accelerate write performance while providing permanence, because writing to memory is much faster than writing to storage (e.g., disk). Storage systems may also implement a buffer cache in the form of an in-memory cache to cache data that is read from data storage media (e.g., local mass storage devices or a storage array associated with the storage system) as well as data modified by write requests. In this manner, in the event a subsequent access relates to data residing within the buffer cache, the data can be served from local, high performance, low latency storage, thereby improving overall performance of the storage system. Virtual storage appliances may use NV storage backed by cloud volumes in place of NVRAM for journaling storage and for the buffer cache. Regardless of whether NVRAM or NV storage is utilized, the modified data may be periodically (e.g., every few seconds) flushed to the data storage media. As the buffer cache may be limited in size, an additional cache level may be provided by a victim cache, typically implemented within a slower memory or storage device than utilized by the buffer cache, that stores data evicted from the buffer cache. The event of saving the modified data to the mass storage devices may be referred to as a CP. At a CP, the file system may save any data that was modified by write requests to persistent data storage media. As will be appreciated, when using a buffer cache, there is a small risk of a system failure occurring between CPs, causing the loss of data modified after the last CP. Consequently, the storage system may maintain an operation log or journal of certain storage operations within the journaling storage media that have been performed since the last CP. This log may include a separate journal entry (e.g., including an operation header) for each storage request received from a client that results in a modification to the file system or data. Such entries for a given file may include, for example, “Create File,” “Write File Data,” and the like. Depending upon the operating mode or configuration of the storage system, each journal entry may also include the data to be written according to the corresponding request. The journal may be used in the event of a failure to recover data that would otherwise be lost. For example, in the event of a failure, it may be possible to replay the journal to reconstruct the current state of stored data just prior to the failure. As described further below, in various examples there may be one or more predefined or configurable triggers (CP triggers). Responsive to a given CP trigger (or at a CP), the file system may save any data that was modified by write requests to persistent data storage media.

As used herein, a “RAID stripe” generally refers to a set of blocks spread across multiple storage devices (e.g., disks of a disk array, disks of a disk shelf, or cloud volumes) to form a parity group (or RAID group).

As used herein, an “allocation area” or “AA” generally refers to a group of RAID stripes. In various examples described herein a single storage pod may be shared by a distributed storage system by assigning ownership of AAs to respective dynamically extensible file systems of a storage system.

As used herein, “ownership” of an AA generally refers to the ability of the owning DEFS to use the AA space (e.g., the blocks associated with the AA) for performance of writes or write operations. In the context of various embodiments described herein, only one DEFS can write to a given block (PVBN) at a time for multiple correctness reasons, so it is the DEFS that owns the given AA of which the given block is associated that has the exclusive ability among all other DEFSs in the storage system to write to the given block. Further, in embodiments described herein, for the file system metadata to be correct, the file system metadata for a given AA is coordinated in one place.

As used herein, a “free allocation area” or “free AA” generally refers to an AA in which no PVBNs of the AA are marked as used, for example, by any active maps of a given dynamically extensible file system.

As used herein, a “partial allocation area” or “partial AA” generally refers to an AA in which one or more PVBNs of the AA are marked as in use (containing valid data), for example, by an active map of a given dynamically extensible file system. As discussed further below, in connection with space balancing, while it is preferable to perform AA ownership changes of free AAs, in various examples, space balancing may involve one dynamically extensible file system donating one or more partial AAs to another dynamically extensible file system. In such cases, the additional cost of copying portions of one or more associated data structures (e.g., bit maps, such as an active map, a refcount map, a summary map, an AA information map, and a space map) relating to storage space information may be incurred. No such additional cost is incurred when moving or changing ownership of free AAs. These associated data structures may, among other things, track which PVBNs are in use, track PVBN counts per AA (e.g., total used blocks and shared references to blocks) and other flags.

As used herein, a “storage pod” generally refers to a group of disks containing multiple RAID groups that are accessible from all storage systems (nodes) of a distributed storage system (cluster).

As used herein, a “data pod” generally refers to a set of storage systems (nodes) that share the same storage pod. In some examples, a data pod refers to a single cluster of nodes representing a distributed storage system. In other examples, there can be multiple data pods in a cluster. Data pods may be used to limit the fault domain and there can be multiple HA pairs of nodes within a data pod.

As used herein, an “active map” is a data structure that contains information indicative of which PVBNs of a distributed file system are in use. In one embodiment, the active map is represented in the form of a sparce bit map in which each PVBN of a global PVBN space of a storage pod has a corresponding Boolean value (or truth value) represented as a single bit, for example, in which the true (1) indicates the corresponding PVBN is in use and false (0) indicates the corresponding PVBN is not in use.

As used herein, a “dynamically extensible file system” or a “DEFS” generally refers to a file system of a data pod or a cluster that has visibility into the entire global PVBN space of a storage pod and hosts multiple volumes. A DEFS may be thought of as a data container or a storage container (which may be referred to as a storage segment container) to which AAs are assigned, thereby resulting in a more flexible and enhanced version of a node-level aggregate. As described further herein (for example, in connection with automatic space balancing), the storage space associated with one or more AAs of a given DEFS may be dynamically transferred or moved on demand to any other DEFS in the cluster by changing the ownership of the one or more AAs and moving associated AA tracking data structures as appropriate. This provides the unique ability to independently scale each DEFS of a cluster. For example, DEFSs can shrink or grow dynamically over time to meet their respective storage needs and silos of storage space are avoided. In one embodiment, a distributed file system comprises multiple instances of the WAFL Copy-on-Write file system running on respective storage systems (nodes) of a distributed storage system (cluster) that represents the data pod. In various examples described herein, a given storage system (node) of a distributed storage system (cluster) may own one or more DEFSs including, for example, a log DEFS for hosting an operation log or journal of certain storage operations that have been performed by the node since the last CP and a data DEFS for hosting customer volumes or logical unit numbers (LUNs). As described further below, the partitioning/division of a storage pod into AAs (creation of a disaggregated storage space) and the distribution of ownership of AAs among DEFSs of multiple nodes of a cluster may facilitate implementation of a distributed storage system having a disaggregated storage architecture. In various examples described herein, each storage system may have its own portion of disaggregated storage to which it has the exclusive ability to perform write access, thereby simplifying storage management by, among otherings, not requiring implementation of access control mechanisms, for example, in the form of locks. At the same time, each storage system also has visibility into the entirety of a global PVBN space, thereby allowing read access by a given storage system to any portion of the disaggregated storage regardless of which node of the cluster is the current owner of the underlying allocation areas. Based disclosure provided herein, those skilled in the art will understand there are at least two types of disaggregation represented/achieved within various examples, including (i) the disaggregation of storage space provided by a storage pod by dividing or partitioning the storage space into AAs the ownership of which can be fluidly changed from one DEFS to another on demand and (ii) the disaggregation of the storage architecture into independent components, including the decoupling of processing resources and storage resources, thereby allowing them to be independently scaled. In one embodiment, the former (which may also be referred to as modular storage, partitioned storage, adaptable storage, or fluid storage) facilitates the latter.

As used herein, an “allocation area map” or “AA map” generally refers to a per dynamically extensible file system data structure or file (e.g., a metafile) that contains information at an AA-level of granularity indicative of which AAs are assigned to or “owned” by a given dynamically extensible file system.

A “node-level aggregate” generally refers to a file system of a single storage system (node) that holds multiple volumes created over one or more RAID groups, in which the node owns the entire PVBN space of the collection of disks of the one or more RAID groups. Node-level aggregates are only accessible from a single storage system (node) of a distributed storage system (cluster) at a time.

As used herein, an “inode” generally refers to a file data structure maintained by a file system that stores metadata for data containers (e.g., directories, subdirectories, disk files, etc.). An inode may include, among other things, location, file size, permissions needed to access a given file with which it is associated as well as creation, read, and write timestamps, and one or more flags.

As used herein, a “storage volume” or “volume” generally refers to a container in which applications, databases, and file systems store data. A volume is a logical component created for the host to access storage on a storage array. A volume may be created from the capacity available in storage pod, a pool, or a volume group. A volume has a defined capacity. Although a volume might consist of more than one drive, a volume appears as one logical component to the host. Non-limiting examples of a volume include a flexible volume and a flexgroup volume.

As used herein, a “flexible volume” generally refers to a type of storage volume that may be efficiently distributed across multiple storage devices. A flexible volume may be capable of being resized to meet changing business or application requirements. In some embodiments, a storage system may provide one or more aggregates and one or more storage volumes distributed across a plurality of nodes interconnected as a cluster. Each of the storage volumes may be configured to store data such as files and logical units. As such, in some embodiments, a flexible volume may be comprised within a storage aggregate and further comprises at least one storage device. The storage aggregate may be abstracted over a RAID plex where each plex comprises a RAID group. Moreover, each RAID group may comprise a plurality of storage disks. As such, a flexible volume may comprise data storage spread over multiple storage disks or devices. A flexible volume may be loosely coupled to its containing aggregate. A flexible volume can share its containing aggregate with other flexible volumes. Thus, a single aggregate can be the shared source of all the storage used by all the flexible volumes contained by that aggregate. A non-limiting example of a flexible volume is a NetApp ONTAP FlexVol volume.

As used herein, a “flexgroup volume” generally refers to a single namespace that is made up of multiple constituent/member volumes. A non-limiting example of a flexgroup volume is a NetApp ONTAP FlexGroup volume that can be managed by storage administrators, and which acts like a NetApp FlexVol volume. In the context of a flexgroup volume, “constituent volume” and “member volume” are interchangeable terms that refer to the underlying volumes (e.g., flexible volumes) that make up the flexgroup volume.

### Example Distributed Storage System Cluster

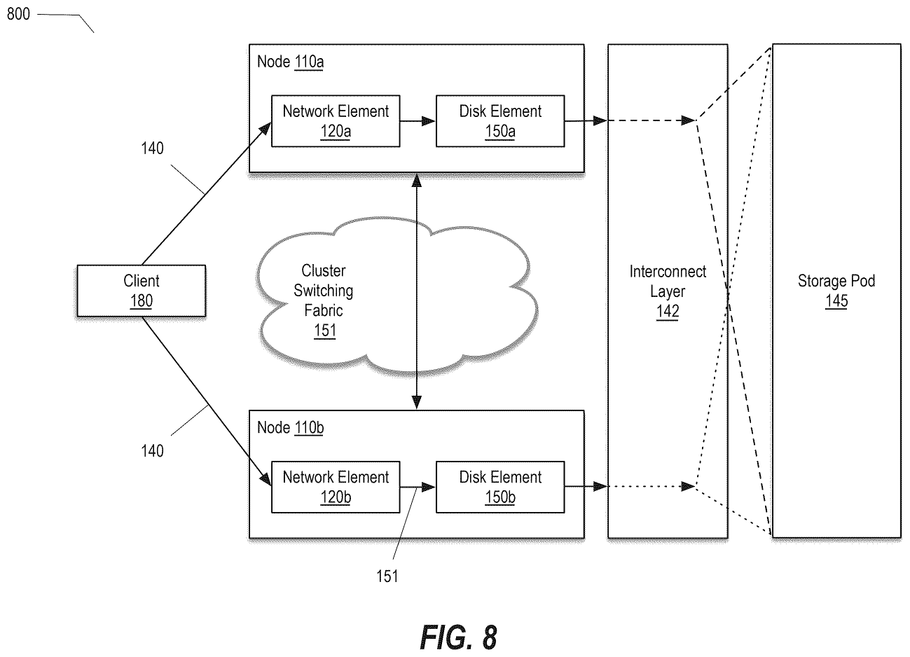

FIG. 8 is a block diagram illustrating a plurality of nodes 110a-b interconnected as a cluster 800 in accordance with an embodiment of the present disclosure. In the context of the present example, the nodes 110a-b comprise various functional components that cooperate to provide a distributed storage system architecture of the cluster 800. To that end, in the context of the present example, each node is generally organized as a network element (e.g., network element 120a or 120b) and a disk element (e.g., disk element 150a or 150b). The network element includes functionality that enables the node to connect to clients (e.g., client 180) over a computer network 140, while each disk element 350 connects to one or more storage devices, such as disks, of one or more disk arrays (not shown) or of one or more storage shelves (not shown), represented as a single shared storage pod 145.

In the context of the present example, the nodes 110a-b are interconnected by a cluster switching fabric 151 which, in an example, may be embodied as a Gigabit Ethernet switch. It should be noted that while there is shown an equal number of network and disk elements in the illustrative cluster 800, there may be differing numbers of network and/or disk elements. For example, there may be a plurality of network elements and/or disk elements interconnected in a cluster configuration 800 that does not reflect a one-to-one correspondence between the network and disk elements. As such, the description of a node comprising one network element and one disk element should be taken as illustrative only.

Clients may be general-purpose computers configured to interact with the node in accordance with a client/server model of information delivery. That is, each client (e.g., client 180) may request the services of the node, and the node may return the results of the services requested by the client, by exchanging packets over the network 140. The client may issue packets including file-based access protocols, such as the Common Internet File System (CIFS) protocol or Network File System (NFS) protocol, over the Transmission Control Protocol/Internet Protocol (TCP/IP) when accessing information in the form of files and directories. Alternatively, the client may issue packets including block-based access protocols, such as the Small Computer Systems Interface (SCSI) protocol encapsulated over TCP (iSCSI) and SCSI encapsulated over Fibre Channel (FCP), when accessing information in the form of blocks. In various examples described herein, an administrative user (not shown) of the client may make use of a user interface (UI) presented by the cluster or a command line interface (CLI) of the cluster to, among other things, establish a data protection relationship between a source volume and a destination volume (e.g., a mirroring relationship specifying one or more policies associated with creation, retention, and transfer of snapshots), defining snapshot and/or backup policies, and association of snapshot policies with snapshots.

Disk elements 150a and 150b are illustratively connected to disks (not shown) within that may be organized into disk arrays within the storage pod 145. Alternatively, storage devices other than disks may be utilized, e.g., flash memory, optical storage, solid state devices, etc. As such, the description of disks should be taken as exemplary only.

In general, various embodiments envision a cluster (e.g., cluster 800) in which every node (e.g., nodes 110a-b) can essentially talk to every storage device (e.g., disk) in the storage pod 145. This is in contrast to the distributed storage system architecture described with reference to FIG. 12. In examples described herein, all nodes (e.g., nodes 110a-b) of the cluster have visibility and read access to an entirety of a global PVBN space of the storage pod 145, for example, via an interconnect layer 142. As described further below, according to one embodiment, the storage within the storage pod 145 is grouped into distinct allocation areas (AAs) than can be assigned to a given dynamically extensible file system (DEFS) of a node to facilitate implementation disaggregated storage. In examples described herein, the AAs assigned to a given DEFS may be said to “own” the assigned AAs and the node owning the given DEFS has the exclusive write access to the associated PVBNs and the exclusive ability to perform write allocation from such blocks. In one embodiment, each node has its own view of a portion of the disaggregated storage represented by the assignment of, for example, via respective allocation area (AA) maps and active maps. This granular assignment of AAs and ability to fluidly change ownership of AAs as needed facilitates the elimination of per-node storage silos and provides higher and more predictable performance, which further translate into improved storage utilization and improvements in cost effectiveness of the storage solution.

Depending on the particular implementation, the interconnect layer 142 may be represented by an intermediate switching topology or some other interconnectivity layer or disk switching layer between the disks in the storage pod 145 and the nodes. Non-limiting examples of the interconnect layer 850 include one or more fiber channel switches or one or more non-volatile memory express (NVMe) fabric switches. Additional details regarding the storage pod 145, DEFSs, AA maps, active maps, and the use, ownership, and sharing (transferring of ownership) of AAs are described further below.

### Example Storage System Node

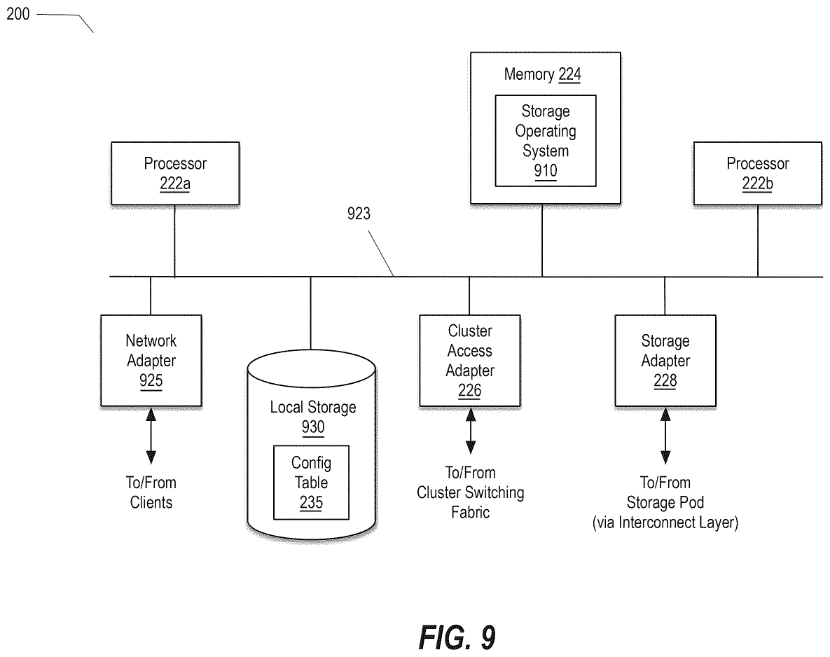

FIG. 9 is a block diagram of a node 200 that is illustratively embodied as a storage system comprising a plurality of processors (e.g., processors 222a-b), a memory 224, a network adapter 925, a cluster access adapter 226, a storage adapter 228 and local storage 930 interconnected by a system bus 923. Node 200 may be analogous to nodes 110a and 110b of FIG. 8. The local storage 930 comprises one or more storage devices, such as disks, utilized by the node to locally store configuration information (e.g., in configuration table 935). The cluster access adapter 226 comprises a plurality of ports adapted to couple the node 200 to other nodes of the cluster (e.g., cluster 800). Illustratively, Ethernet is used as the clustering protocol and interconnect media, although it will be apparent to those skilled in the art that other types of protocols and interconnects may be utilized within the cluster architecture described herein. Alternatively, where the network elements and disk elements are implemented on separate storage systems or computers, the cluster access adapter 226 is utilized by the network and disk element for communicating with other network and disk elements in the cluster.

In the context of the present example, each node 200 is illustratively embodied as a dual processor storage system executing a storage operating system 910 that implements a high-level module, such as a file system, to logically organize the information as a hierarchical structure of named directories, files and special types of files called virtual disks (hereinafter generally “blocks”) on the disks. However, it will be apparent to those of ordinary skill in the art that the node 200 may alternatively comprise a single or more than two processor system. Illustratively, one processor (e.g., processor 222a) may execute the functions of the network element (e.g., network element 120a or 120b) on the node, while the other processor (e.g., processor 222b) may execute the functions of the disk element (e.g., disk element 150a or 150b).

The memory 224 illustratively comprises storage locations that are addressable by the processors and adapters for storing software program code and data structures associated with the subject matter of the disclosure. The processor and adapters may, in turn, comprise processing elements and/or logic circuitry configured to execute the software code and manipulate the data structures. The storage operating system 910, portions of which is typically resident in memory and executed by the processing elements, functionally organizes the node 200 by, inter alia, invoking storage operations in support of the storage service implemented by the node. It will be apparent to those skilled in the art that other processing and memory means, including various computer readable media, may be used for storing and executing program instructions pertaining to the disclosure described herein.

The network adapter 925 comprises a plurality of ports adapted to couple the node 200 to one or more clients (e.g., client 180) over point-to-point links, wide area networks, virtual private networks implemented over a public network (Internet) or a shared local area network. The network adapter 925 thus may comprise the mechanical, electrical and signaling circuitry needed to connect the node to a network (e.g., computer network 140). Illustratively, the network may be embodied as an Ethernet network or a Fibre Channel (FC) network. Each client (e.g., client 180) may communicate with the node over network by exchanging discrete frames or packets of data according to pre-defined protocols, such as TCP/IP.

The storage adapter 228 cooperates with the storage operating system 910 executing on the node 200 to access information requested by the clients. The information may be stored on any type of attached array of writable storage device media such as video tape, optical, DVD, magnetic tape, bubble memory, electronic random access memory, micro-electromechanical and any other similar media adapted to store information, including data and parity information. However, as illustratively described herein, the information is stored on disks (e.g., associated with storage pod 145). The storage adapter comprises a plurality of ports having input/output (I/O) interface circuitry that couples to the disks over an I/O interconnect arrangement, such as a conventional high-performance, FC link topology.

Storage of information on each disk array may be implemented as one or more storage “volumes” that comprise a collection of physical storage disks or cloud volumes cooperating to define an overall logical arrangement of volume block number (VBN) space on the volume(s). Each logical volume is generally, although not necessarily, associated with its own file system. The disks within a logical volume/file system are typically organized as one or more groups, wherein each group may be operated as a Redundant Array of Independent (or Inexpensive) Disks (RAID). Most RAID implementations, such as a RAID-4 level implementation, enhance the reliability/integrity of data storage through the redundant writing of data “stripes” across a given number of physical disks in the RAID group, and the appropriate storing of parity information with respect to the striped data. An illustrative example of a RAID implementation is a RAID-4 level implementation, although it should be understood that other types and levels of RAID implementations may be used in accordance with the inventive principles described herein.

While in the context of the present example, the node may be a physical host, it is to be appreciated the node may be implemented in virtual form. For example, a storage system may be run (e.g., on a VM or as a containerized instance, as the case may be) within a public cloud provider. As such, a cluster representing a distributed storage system may be comprised of multiple physical nodes (e.g., node 200) or multiple virtual nodes (virtual storage systems).

### Example Storage Operating System

To facilitate access to the disks (e.g., disks within one or more disk arrays of a storage pod, such as storage pod 145 of FIG. 8), a storage operating system (e.g., storage operating system 300, which may be analogous to storage operating system 910) may implement a write-anywhere file system that cooperates with one or more virtualization modules to “virtualize” the storage space provided by disks. The file system logically organizes the information as a hierarchical structure of named directories and files on the disks. Each “on-disk” file may be implemented as set of disk blocks configured to store information, such as data, whereas the directory may be implemented as a specially formatted file in which names and links to other files and directories are stored. The virtualization module(s) allow the file system to further logically organize information as a hierarchical structure of blocks on the disks that are exported as named logical unit numbers (LUNs).

Illustratively, the storage operating system may be the Data ONTAP operating system available from NetApp, Inc., San Jose, Calif. that implements the WAFL file system. However, it is expressly contemplated that any appropriate storage operating system may be enhanced for use in accordance with the inventive principles described herein. As such, where the term “WAFL” is employed, it should be taken broadly to refer to any file system that is otherwise adaptable to the teachings of this disclosure.

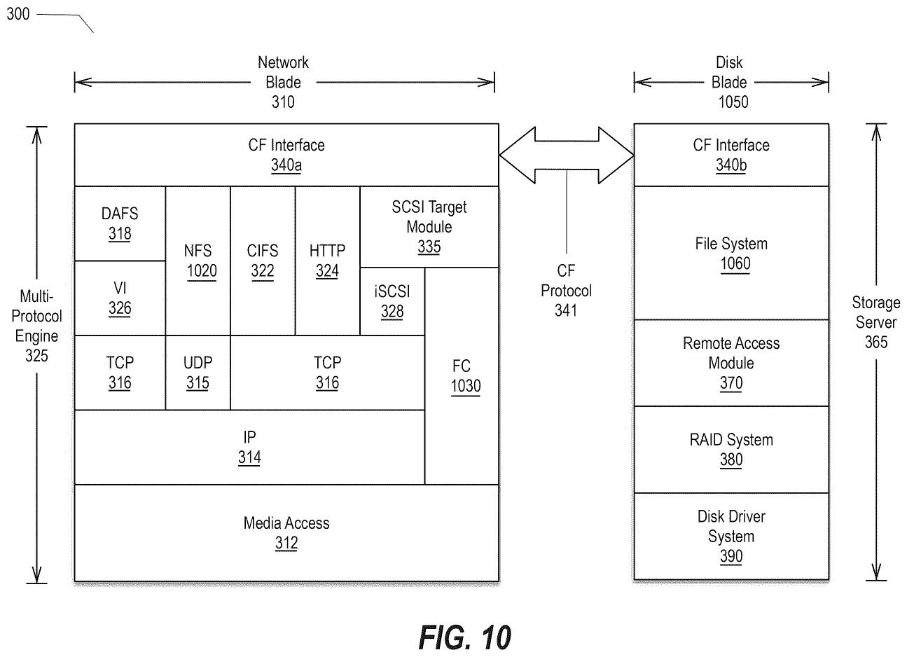

FIG. 10 is a block diagram illustrating a storage operating system 300 in accordance with an embodiment of the present disclosure. In the context of the present example, the storage operating system 300 is shown including a series of software layers organized to form an integrated network protocol stack or, more generally, a multi-protocol engine 325 that provides data paths for clients to access information stored on the node using block and file access protocols. The multi-protocol engine includes a media access layer 312 of network drivers (e.g., gigabit Ethernet drivers) that interfaces to network protocol layers, such as the IP layer 314 and its supporting transport mechanisms, the TCP layer 316 and the User Datagram Protocol (UDP) layer 315. A file system protocol layer provides multi-protocol file access and, to that end, includes support for the Direct Access File System (DAFS) protocol 318, the NFS protocol 1020, the CIFS protocol 322 and the Hypertext Transfer Protocol (HTTP) protocol 324. A VI layer 326 implements the VI architecture to provide direct access transport (DAT) capabilities, such as RDMA, as required by the DAFS protocol 318. An iSCSI driver layer 328 provides block protocol access over the TCP/IP network protocol layers, while a FC driver layer 1030 receives and transmits block access requests and responses to and from the node. The FC and iSCSI drivers provide FC-specific and iSCSI-specific access control to the blocks and, thus, manage exports of LUNs to either iSCSI or FCP or, alternatively, to both iSCSI and FCP when accessing the blocks on the node (e.g., node 200).

In addition, the storage operating system may include a series of software layers organized to form a storage server 365 that provides data paths for accessing information stored on the disks (e.g., disks 130) of the node. To that end, the storage server 365 includes a file system module 1060 in cooperating relation with a remote access module 370, a RAID system module 380 and a disk driver system module 390. The RAID system 380 manages the storage and retrieval of information to and from the volumes/disks in accordance with I/O operations, while the disk driver system 390 implements a disk access protocol such as, e.g., the SCSI protocol.

The file system 1060 may implement a virtualization system of the storage operating system 300 through the interaction with one or more virtualization modules illustratively embodied as, for example, a virtual disk (vdisk) module (not shown) and a SCSI target module 335. The SCSI target module 335 is generally disposed between the FC and iSCSI drivers 328, 1030 and the file system 1060 to provide a translation layer of the virtualization system between the block (LUN) space and the file system space, where LUNs are represented as blocks.

The file system 1060 is illustratively a message-based system that provides logical volume management capabilities for use in access to the information stored on the storage devices, such as disks. That is, in addition to providing file system semantics, the file system 1060 provides functions normally associated with a volume manager. These functions include (i) aggregation of the disks, (ii) aggregation of storage bandwidth of the disks, and (iii) reliability guarantees, such as mirroring and/or parity (RAID). The file system 1060 illustratively implements an exemplary a file system having an on-disk format representation that is block-based using, e.g., 4 kilobyte (KB) blocks and using index nodes (“inodes”) to identify files and file attributes (such as creation time, access permissions, size and block location). The file system uses files to store meta-data describing the layout of its file system; these meta-data files include, among others, an inode file. A file handle, i.e., an identifier that includes an inode number, is used to retrieve an inode from disk.

Broadly stated, all inodes of the write-anywhere file system are organized into the inode file. A file system (fs) info block specifies the layout of information in the file system and includes an inode of a file that includes all other inodes of the file system. Each logical volume (file system) has an fsinfo block that is preferably stored at a fixed location within, e.g., a RAID group. The inode of the inode file may directly reference (point to) data blocks of the inode file or may reference indirect blocks of the inode file that, in turn, reference data blocks of the inode file. Within each data block of the inode file are embedded inodes, each of which may reference indirect blocks that, in turn, reference data blocks of a file.

Operationally, a request from a client (e.g., client 180) is forwarded as a packet over a computer network (e.g., computer network 140) and onto a node (e.g., node 200) where it is received at a network adapter (e.g., network adapter 925). A network driver (of layer 312 or layer 1030) processes the packet and, if appropriate, passes it on to a network protocol and file access layer for additional processing prior to forwarding to the write-anywhere file system 1060. Here, the file system generates operations to load (retrieve) the requested data from disk 130 if it is not resident “in core”, i.e., in memory 224. If the information is not in memory, the file system 1060 indexes into the inode file using the inode number to access an appropriate entry and retrieve a logical VBN. The file system then passes a message structure including the logical VBN to the RAID system 380; the logical VBN is mapped to a disk identifier and disk block number (disk, dbn) and sent to an appropriate driver (e.g., SCSI) of the disk driver system 390. The disk driver accesses the dbn from the specified disk 130 and loads the requested data block(s) in memory for processing by the node. Upon completion of the request, the node (and operating system) returns a reply to the client 180 over the network 140.

The remote access module 370 is operatively interfaced between the file system module 1060 and the RAID system module 380. Remote access module 370 is illustratively configured as part of the file system to implement the functionality to determine whether a newly created data container, such as a subdirectory, should be stored locally or remotely. Alternatively, the remote access module 370 may be separate from the file system. As such, the description of the remote access module being part of the file system should be taken as exemplary only. Further, the remote access module 370 determines which remote flexible volume should store a new subdirectory if a determination is made that the subdirectory is to be stored remotely. More generally, the remote access module 370 implements the heuristics algorithms used for the adaptive data placement. However, it should be noted that the use of a remote access module should be taken as illustrative. In alternative aspects, the functionality may be integrated into the file system or other module of the storage operating system. As such, the description of the remote access module 370 performing certain functions should be taken as exemplary only.

It should be noted that the software “path” through the storage operating system layers described above needed to perform data storage access for the client request received at the node may alternatively be implemented in hardware. That is, a storage access request data path may be implemented as logic circuitry embodied within a field programmable gate array (FPGA) or an application specific integrated circuit (ASIC). This type of hardware implementation increases the performance of the storage service provided by node 200 in response to a request issued by client 180. Alternatively, the processing elements of adapters 925, 228 may be configured to offload some or all of the packet processing and storage access operations, respectively, from processor 222, to thereby increase the performance of the storage service provided by the node. It is expressly contemplated that the various processes, architectures and procedures described herein can be implemented in hardware, firmware or software.

As used herein, the term “storage operating system” generally refers to the computer-executable code operable on a computer to perform a storage function that manages data access and may, in the case of a node (e.g., node 200), implement data access semantics of a general purpose operating system. The storage operating system can also be implemented as a microkernel, an application program operating over a general-purpose operating system, such as UNIX or Windows NT, or as a general-purpose operating system with configurable functionality, which is configured for storage applications as described herein.

In addition, it will be understood to those skilled in the art that aspects of the disclosure described herein may apply to any type of special-purpose (e.g., file server, filer or storage serving appliance) or general-purpose computer, including a standalone computer or portion thereof, embodied as or including a storage system. Moreover, the teachings contained herein can be adapted to a variety of storage system architectures including, but not limited to, a network-attached storage environment, a storage area network and disk assembly directly attached to a client or host computer. The term “storage system” should therefore be taken broadly to include such arrangements in addition to any subsystems configured to perform a storage function and associated with other equipment or systems. It should be noted that while this description is written in terms of a write anywhere file system, the teachings of the subject matter may be utilized with any suitable file system, including a write in place file system.

### Example Cluster Fabric (CF) Protocol

Illustratively, the storage server 365 is embodied as disk element (or disk blade 1050, which may be analogous to disk element 150a or 150b) of the storage operating system 300 to service one or more volumes of array 160. In addition, the multi-protocol engine 325 is embodied as network element (or network blade 310, which may be analogous to network element 120a or 120b) to (i) perform protocol termination with respect to a client issuing incoming data access request packets over the network (e.g., network 140), as well as (ii) redirect those data access requests to any storage server 365 of the cluster (e.g., cluster 800). Moreover, the network element 310 and disk element 1050 cooperate to provide a highly scalable, distributed storage system architecture of the cluster. To that end, each module may include a cluster fabric (CF) interface module (e.g., CF interface 340a and 340b) adapted to implement intra-cluster communication among the nodes (e.g., node 110a and 110b). In the context of a distributed storage architecture as described below with reference to FIG. 12 in which node-level aggregates are employed, the CF protocol facilitates, among other things, internode communications relating to data access requests. It is to be appreciated such internode communications relating to data access requests are not needed in the context of a distributed storage architecture as described below with reference to FIG. 13 in which each node of a cluster has visibility and access to the entirety of a global PVBN space of a storage pod (via their respective DEFSs). However, in various embodiments, some limited amount of internode communications, for example, relating to storage space reporting (or simply space reporting) and storage space requests (e.g., requests for donations of AAs) continue to be useful. As described further below, such internode communications may make use of the CF protocol or other forms of internode communications, including message passing via on-wire communications and/or the use of one or more persistent message queues (or on-disk message queues), which may make use of the fact that all nodes can read from all disk of a storage pod. For example, a persistent message queue may be maintained at the node and/or DEFS-level of granularity in which each node and/or DEFS has a message queue to which others can post messages destined for the node or DEFS (as the case may be). In one embodiment, each DEFS has an associated inbound queue on which it receives messages sent by another DEFS in the cluster and an associated outbound queue on which it posts messages intended for delivery to another DEFS in the cluster

The protocol layers, e.g., the NFS/CIFS layers and the iSCSI/IFC layers, of the network element 310 may function as protocol servers that translate file-based and block based data access requests from clients into CF protocol messages used for communication with the disk element 1050. That is, the network element servers may convert the incoming data access requests into file system primitive operations (commands) that are embedded within CF messages by the CF interface module 340a for transmission to the disk elements of the cluster.

Further, in an illustrative aspect of the disclosure, the network element and disk element are implemented as separately scheduled processes of storage operating system 300; however, in an alternate aspect, the modules may be implemented as pieces of code within a single operating system process. Communication between a network element and disk element may thus illustratively be effected through the use of message passing between the modules although, in the case of remote communication between a network element and disk element of different nodes, such message passing occurs over a cluster switching fabric (e.g., cluster switching fabric 151). A known message-passing mechanism provided by the storage operating system to transfer information between modules (processes) is the Inter Process Communication (IPC) mechanism. The protocol used with the IPC mechanism is illustratively a generic file and/or block-based “agnostic” CF protocol that comprises a collection of methods/functions constituting a CF application programming interface (API). Examples of such an agnostic protocol are the SpinFS and SpinNP protocols available from NetApp, Inc.

The CF interface module 340 implements the CF protocol for communicating file system commands among the nodes or modules of cluster. Communication may be illustratively effected by the disk element exposing the CF API to which a network element (or another disk element) issues calls. To that end, the CF interface module 340 may be organized as a CF encoder and CF decoder. The CF encoder of, e.g., CF interface 340a on network element 310 encapsulates a CF message as (i) a local procedure call (LPC) when communicating a file system command to a disk element 1050 residing on the same node 200 or (ii) a remote procedure call (RPC) when communicating the command to a disk element residing on a remote node of the cluster 800. In either case, the CF decoder of CF interface 340b on disk element 1050 de-encapsulates the CF message and processes the file system command.

Illustratively, the remote access module 370 may utilize CF messages to communicate with remote nodes to collect information relating to remote flexible volumes. A CF message is used for RPC communication over the switching fabric between remote modules of the cluster; however, it should be understood that the term “CF message” may be used generally to refer to LPC and RPC communication between modules of the cluster. The CF message includes a media access layer, an IP layer, a UDP layer, a reliable connection (RC) layer and a CF protocol layer. The CF protocol is a generic file system protocol that may convey file system commands related to operations contained within client requests to access data containers stored on the cluster; the CF protocol layer is that portion of a message that carries the file system commands. Illustratively, the CF protocol is datagram based and, as such, involves transmission of messages or “envelopes” in a reliable manner from a source (e.g., a network element 310) to a destination (e.g., a disk element 1050). The RC layer implements a reliable transport protocol that is adapted to process such envelopes in accordance with a connectionless protocol, such as UDP.

### Example File System Layout

In one embodiment, a data container is represented in the write-anywhere file system as an inode data structure adapted for storage on the disks of a storage pod (e.g., storage pod 145). In such an embodiment, an inode includes a meta-data section and a data section. The information stored in the meta-data section of each inode describes the data container (e.g., a file, a snapshot, etc.) and, as such, includes the type (e.g., regular, directory, vdisk) of file, its size, time stamps (e.g., access and/or modification time) and ownership (e.g., user identifier (UID) and group ID (GID), of the file, and a generation number. The contents of the data section of each inode may be interpreted differently depending upon the type of file (inode) defined within the type field. For example, the data section of a directory inode includes meta-data controlled by the file system, whereas the data section of a regular inode includes file system data. In this latter case, the data section includes a representation of the data associated with the file.

Specifically, the data section of a regular on-disk inode may include file system data or pointers, the latter referencing 4 KB data blocks on disk used to store the file system data. Each pointer is preferably a logical VBN to facilitate efficiency among the file system and the RAID system when accessing the data on disks. Given the restricted size (e.g., 128 bytes) of the inode, file system data having a size that is less than or equal to 64 bytes is represented, in its entirety, within the data section of that inode. However, if the length of the contents of the data container exceeds 64 bytes but less than or equal to 64 KB, then the data section of the inode (e.g., a first level inode) comprises up to 16 pointers, each of which references a 4 KB block of data on the disk.

Moreover, if the size of the data is greater than 64 KB but less than or equal to 64 megabytes (MB), then each pointer in the data section of the inode (e.g., a second level inode) references an indirect block (e.g., a first level L1 block) that contains 224 pointers, each of which references a 4 KB data block on disk. For file system data having a size greater than 64 MB, each pointer in the data section of the inode (e.g., a third level L3 inode) references a double-indirect block (e.g., a second level L2 block) that contains 224 pointers, each referencing an indirect (e.g., a first level L1) block. The indirect block, in turn, which contains 224 pointers, each of which references a 4 kB data block on disk. When accessing a file, each block of the file may be loaded from disk into memory (e.g., memory 224). In other embodiments, higher levels are also possible that may be used to handle larger data container sizes.

When an on-disk inode (or block) is loaded from disk into memory, its corresponding in-core structure embeds the on-disk structure. The in-core structure is a block of memory that stores the on-disk structure plus additional information needed to manage data in the memory (but not on disk). The additional information may include, e.g., a “dirty” bit. After data in the inode (or block) is updated/modified as instructed by, e.g., a write operation, the modified data is marked “dirty” using the dirty bit so that the inode (block) can be subsequently “flushed” (stored) to disk.

According to one embodiment, a file in a file system comprises a buffer tree that provides an internal representation of blocks for a file loaded into memory and maintained by the write-anywhere file system 1060. A root (top-level) buffer, such as the data section embedded in an inode, references indirect (e.g., level 1) blocks. In other embodiments, there may be additional levels of indirect blocks (e.g., level 2, level 3) depending upon the size of the file. The indirect blocks (e.g., and inode) includes pointers that ultimately reference data blocks used to store the actual data of the file. That is, the data of file are contained in data blocks and the locations of these blocks are stored in the indirect blocks of the file. Each level 1 indirect block may include pointers to as many as 224 data blocks. According to the “write anywhere” nature of the file system, these blocks may be located anywhere on the disks.

In one embodiment, a file system layout is provided that apportions an underlying physical volume into one or more virtual volumes (or flexible volumes) of a storage system, such as node 200. In such an embodiment, the underlying physical volume is an aggregate comprising one or more groups of disks, such as RAID groups, of the node. The aggregate has its own physical volume block number (PVBN) space and maintains meta-data, such as block allocation structures, within that PVBN space. Each flexible volume has its own virtual volume block number (VVBN) space and maintains meta-data, such as block allocation structures, within that VVBN space. Each flexible volume is a file system that is associated with a container file; the container file is a file in the aggregate that contains all blocks used by the flexible volume. Moreover, each flexible volume comprises data blocks and indirect blocks that contain block pointers that point at either other indirect blocks or data blocks.

In a further embodiment, PVBNs are used as block pointers within buffer trees of files stored in a flexible volume. This “hybrid” flexible volume example involves the insertion of only the PVBN in the parent indirect block (e.g., inode or indirect block). On a read path of a logical volume, a “logical” volume (vol) info block has one or more pointers that reference one or more fsinfo blocks, each of which, in turn, points to an inode file and its corresponding inode buffer tree. The read path on a flexible volume is generally the same, following PVBNs (instead of VVBNs) to find appropriate locations of blocks; in this context, the read path (and corresponding read performance) of a flexible volume is substantially similar to that of a physical volume. Translation from PVBN-to-disk, dbn occurs at the file system/RAID system boundary of the storage operating system 300.

In a dual VBN hybrid flexible volume example, both a PVBN and its corresponding VVBN are inserted in the parent indirect blocks in the buffer tree of a file. That is, the PVBN and VVBN are stored as a pair for each block pointer in most buffer tree structures that have pointers to other blocks, e.g., level 1 (L1) indirect blocks, inode file level 0 (L0) blocks.

A root (top-level) buffer, such as the data section embedded in an inode, references indirect (e.g., level 1) blocks. Note that there may be additional levels of indirect blocks (e.g., level 2, level 3) depending upon the size of the file. The indirect blocks (and inode) include PVBN/VVBN pointer pair structures that ultimately reference data blocks used to store the actual data of the file. The PVBNs reference locations on disks of the aggregate, whereas the VVBNs reference locations within files of the flexible volume. The use of PVBNs as block pointers in the indirect blocks provides efficiencies in the read paths, while the use of VVBN block pointers provides efficient access to required meta-data. That is, when freeing a block of a file, the parent indirect block in the file contains readily available VVBN block pointers, which avoids the latency associated with accessing an owner map to perform PVBN-to-VVBN translations; yet, on the read path, the PVBN is available.

### Example Hierarchical Inode Tree

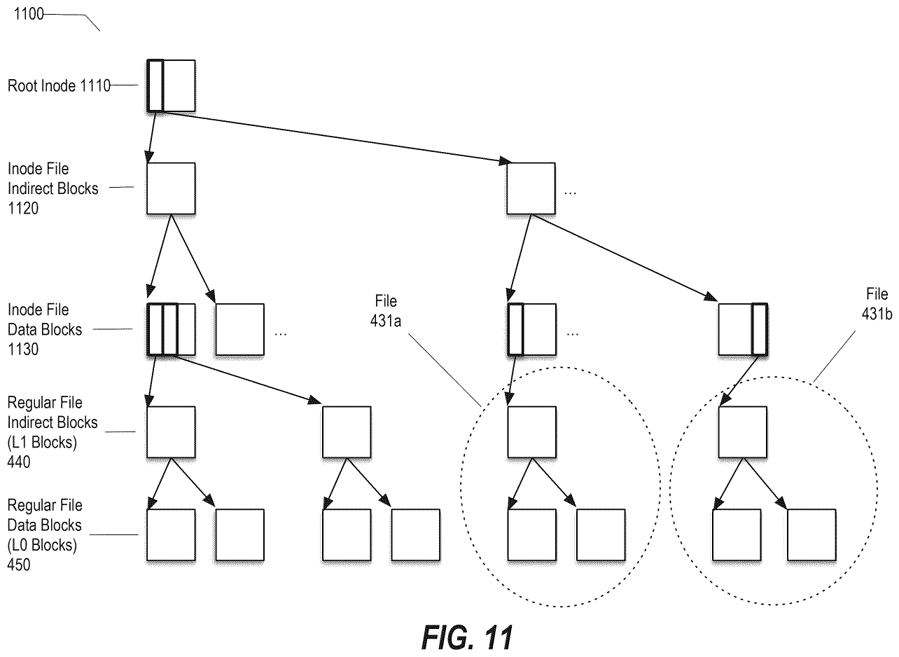

FIG. 11 is a block diagram illustrating a tree of blocks 1100 representing a simplified view of an example a file system layout in accordance with an embodiment of the present disclosure. In one embodiment, the data storage system nodes (e.g., data storage systems 110a-b) make use of a write anywhere file system (e.g., the WAFL file system). The write anywhere file system may represent a UNIX compatible file system that is optimized for network file access. In the context of the present example, the write anywhere file system is a block-based file system that represents file system data (e.g., a block map file and an inode map file), meta-data files, and data containers (e.g., volumes, subdirectories, and regular files) in a tree of blocks (e.g., tree of blocks 1100). Keeping meta-data in files allows the file system to write meta-data blocks anywhere on disk and makes it easier to increase the size of the file system on the fly.

In this simplified example, the tree of blocks 1100 has a root inode 1110, which describes an inode map file (not shown), made up of inode file indirect blocks 1120 and inode file data blocks 1130. In this example, the file system uses inodes (e.g., inode file data blocks 1130) to describe data containers representing files (e.g., file 431a and file 431b). In one embodiment, each inode contains 16 block pointers to indicate which blocks (e.g., of 4 KB) belong to a given data container (e.g., a file). Inodes for data containers smaller than 64 KB may use the 156 block pointers to point to file data blocks or simply data blocks (e.g., regular file data blocks, which may also be referred to herein as L0 blocks 450). Inodes for files smaller than 64 MB may point to indirect blocks (e.g., regular file indirect blocks, which may also be referred to herein as L1 blocks 440), which point to actual file data. Inodes for larger files or data containers may point to doubly indirect blocks. For very small files, data may be stored in the inode itself in place of the block pointers.

As will be appreciated by those skilled in the art given the above-described file system layout, yet another advantage of DEFSs are their ability to facilitate storage space balancing and/or load balancing. This comes from the fact that the entire global PVBN space of a storage pod is visible to all DEFSs of the cluster and therefore any given DEFS can get access to an entire file by copying the top-most PVBN from the inode on another tree.

### Example of a Distributed Storage System Architecture With Storage Silos

FIG. 12 is a block diagram illustrating a distributed storage system architecture 500 in which the entirety of a given disk and a given RAID group are owned by an aggregate and the aggregate file system is only visible from one node, thereby resulting in silos of storage space. In the context of FIG. 12, node 510a and node 510b may represent a two-node cluster in which the nodes are high-availability (HA) partners. For example, one node may represent a primary node and the other may represent a secondary node in which pairwise disk connectively supports a pairwise failover model. As shown, each node includes respective active maps (e.g., active map 541a and active map 541b) and a sets of disks (in this case, ten disks) they can talk to. The nodes may partition the disks among themselves as aggregates (e.g., data aggregate 520a and data aggregate 520b) and at steady state both nodes will work on their own subset of disks representing a one or more RAID groups (in this case, four data disks and one parity disk, forming a single RAID group). A RAID layer or subsystem (not shown) of a storage operating system (not shown) of each node may present respective separate and independent PVBN spaces (e.g., PVBN space 540a and PVBN space 540b) to a file system layer (not shown) of the node.

In this example, therefore, data aggregate 520a has visibility only to a first PVBN space (e.g., PVBN space 540a) and data aggregate 520b has visibility only to a second PVBN space (e.g., PVBN space 540b). When data is stored to volume 530a or 530b, it is striped across the subset of disks that are part of data aggregate 520a; and when data is stored to volume 530c or 530d, it is are striped across the subset of disks that are part of data aggregate 520b. Active map 541a is a data structure (e.g., a bit map with one bit per PVBN) that that identifies the PVBNs within PVBN space 540a that are in use by data aggregate 520a. Similarly, active map 541b is a data structure (e.g., a bit map with one bit per PVBN) that that identifies the PVBNs within PVBN space 540b that are in use by data aggregate 520b.

As can be seen, for any given disk, the entire disk is owned by a particular aggregate and the aggregate file system is only visible from one node. Similarly, for any given RAID group, the available storage space of the entire RAID group is useable only by a single node. There are various other disadvantages to the architecture shown in FIG. 12. For example, moving a volume from one aggregate to another requires copying of data (e.g., reading all the blocks used by the volume and writing them to the new location), with an elaborate handover sequence between the aggregates involved. Additionally, there are scenarios in which one data aggregate may run out of storage space while the other still has plentiful free storage space, resulting in ineffective usage of the storage space provided by the disks. While the size of the PVBN space of an aggregate may be increased, doing so typically requires an administrative user to monitor the storage space on each node-level aggregate and add one or more disks and/or RAID groups to the aggregate. As described further below with reference to FIG. 13A, with DEFSs storage space is added to a common pool of storage referred to herein as a “storage pod” and space is available for consumption by any DEFS in the cluster, thereby making space management much simpler and facilitating the automatic balancing of storage space without administrator involvement.

### Example Distributed System Architecture Providing Disaggregated Storage

Before getting into the details of a particular example, various properties, constructs, and principles relating to the use and implementation of DEFSs will now be discussed. As noted above, it is desirable to make the global PVBN space of the entire storage pool available on each DEFS of a data pod, which may include one or more clusters. This feature facilitates the performance of, among other things, instant copy-free moves of volumes from one DEFS to another, for example, in connection with performing load balancing. Creating clones on remote nodes for load balancing is yet another benefit. With a global PVBN space, support for global data deduplication can also be supported rather than deduplication being limited to node-level aggregates.

It is also beneficial, in terms of performance, to avoid the use of access control mechanism, such as locks, to coordinate write accesses and write allocation among nodes generally and DEFSs specifically. Such access control mechanisms may be eliminated by specifying, at a per-DEFS level, those portions of the disaggregated storage of the storage pod to which a given DEFS has exclusive write access. For example, as described further below, a DEFS may be limited to use of only the AAs associated with (assigned to or owned by) the DEFS for performing write allocation and write accesses during a CP. Advantageously, given the visibility into the entire global PVBN space, reads can be performed by any DEFS of the cluster from all the PVBNs in the storage pod.

Each DEFS of a given cluster (or data pod, as the case may be) may start at its own super block. As shown and described with reference to FIG. 13A, a predefined AA (e.g., the first AA) in storage pod may be dedicated for super blocks. In one embodiment, a set of RAID stripes within the predefined super block AA (e.g., the first AA of the storage pod) may be dedicated for super blocks. In this predefined super block AA, ownership may be specified at the granularity of a single RAID stripe instead of at the AA granularity of multiple RAID stripes representing one or more GB (e.g., between approximately 1 GB and 10 GB) of storage space. The location of a super block of a given DEFS can be mathematically derived using an identifier (a DEFS ID) associated with the given DEFS. Since the RAID stripe is already reserved for a super block, it can be replicated on N disks.

Each DEFS has AAs associated with it, which may be thought of conceptually as the DEFS owning those AAs. In one embodiment, AAs may be tracked within an AA map and persisted within the DEFS filesystem. An AA map may include the DEFS ID in an AA index. While AA ownership information regarding other DEFSs in the cluster may be cached in the AA map of a given DEFS, which may be useful during the PVBN free path, for example, to facilitate freeing of PVBNs of an AA not owned by the given DEFS (which may arise in situations in which partial AAs are donated from one DEFS to another), the authoritative source information regarding the AAs owned by a given DEFS may be presumed to be in the AA map of the given DEFS.

In support of avoiding storage silos and supporting the more fluid use of disk space across all nodes of a cluster, DEFSs may be allowed to donate partially or completely free AAs to other DEFSs.

Each DEFS may have its own label information kept in the file system. The label information may be kept in the super block or another well-known location outside of the file system.

In various examples, there can be multiple DEFSs on a RAID tree. That is, there may be a many-to-one association between DEFSs and a RAID tree, in which each DEFS may have a reference on the RAID tree. The RAID tree can still have multiple RAID groups. In various examples described herein, it is assumed the PVBN space provided by the RAID tree is continuous.

It may be helpful to have a root DEFS and a data DEFS that are transparent to other subsystems. These DEFSs may be useful for storing information that might be needed before the file system is brought online. Examples of such information may include controller (node) failover (CFO) and storage failover (SFO) properties/policies. HA is one example of where it might be helpful to bring up a controller (node) failover root DEFS first before giving back the storage failover data DEFSs. HA coordination of bringing down a given DEFS on takeover/giveback may be handled by the file system (e.g., WAFL) since the RAID tree would be up until the node is shutdown.

DEFS data structures (e.g., DEFS bit maps at the PVBN level, such as active maps and reference count (refcount) maps) may be sparse. That is, they may represent the entire global PVBN space, but only include valid truth values for PVBNs of AAs that are owned by the particular DEFS with which they are associated. When validation of these bit maps is performed by or on behalf of a particular DEFS, the bits should be validated only for the AA areas owned by the particular DEFS. When using such sparce data structures, to get the complete picture of the PVBN space, the data structures in all of the nodes should be taken into consideration. While various DEFS data structures may be discussed herein as if they were separate metafiles, it is to be appreciated, given the visibility by each node into the entire global PVBN space, one or more of such DEFS data structures may be represented as cluster-wide metafiles. Such a cluster-wide metafile may be persisted in a private inode space that is not accessible to end users and the relevant portions for a particular DEFS may be located based on the DEFS ID of the particular DEFS, for example, which may be associated with the appropriate inode (e.g., an L0 block). Similarly, the entirety of such a cluster-wide metafile may be accessible based on a cluster ID, for example, which may be associated with a higher-level inode in the hierarchy (e.g., an L1 block). In any event, each node should generally have all the information it needs to work independently until and unless it runs out of storage space or meets a predetermined or configurable threshold of a storage space metric (e.g., a free space metric or a used space metric), for example, relative to the other nodes of the cluster. At that point, as described further below, as part of a space monitoring and/or a space balancing process, the node may request a portion of AAs of DEFSs owned by one or more of such other nodes be donated so as to increase the useable storage space of one or more DEFSs of the node at issue.

FIG. 13A is a block diagram illustrating a distributed storage system architecture 600 that includes multiple storage nodes with each storage node having a DEFS for managing allocation of storage blocks in accordance with an embodiment of the present disclosure. Various architectural advantages of the proposed distributed storage system architecture and mechanisms for providing and making use of disaggregated storage include, but are not limited to, the ability to batch freed blocks in remote free logs from a local node to a remote node owning the freed blocks, perform automatic space balancing among DEFSs, perform elastic node growth and shrinkage for a cluster, perform elastic storage growth of the storage pod, perform zero-copy file and volume move (migration), perform distributed RAID rebuild, achieve HA cost reduction using volume rehosting, create remote clones, and perform global data deduplication.

In the context of the present example, the nodes (e.g., node 610a and 610b) of a cluster, which may represent a data pod or include multiple data pods, each include respective data dynamically extensible file systems (DEFSs) (e.g., data DEFS 620a and data DEFS 620b) and respective log DEFSs (e.g., log DEFS 625a and log DEFS 625b). In general, data DEFSs (or analogous to flexible aggregate 620a, flexible aggregate 620b) may be used for persisting data on behalf of clients (e.g., client 180), whereas log DEFSs may be used to maintain an operation log or journal of certain storage operations within the journaling storage media that have been performed since the last CP. The data DEFS 620a may include a local free log 628a to temporarily store blocks to be freed that are owned by DEFS 620a and a remote free log 628b to temporarily store blocks to be freed that are owned by DEFS 620b. In a similar manner, the data DEFS 620b may include a local free log 628c to temporarily store blocks to be freed that are owned by DEFS 620b and a remote free log 628d to temporarily store blocks to be freed that are owned by DEFS 620a.

It should be noted that while for simplicity only two nodes, which may be configured as part of an HA pair for fault tolerance and nondisruptive operations, are shown in the illustrative cluster depicted in FIG. 13A, there may be one or more additional nodes in a given cluster. For example, there may be multiple HA pairs within a cluster (or a data pod of the cluster, which may represent a mechanism to limit the fault domain). As such, the description of this two-node cluster should be taken as illustrative only. Furthermore, while in some examples HA may be achieved by defining pairs of nodes within a cluster as HA partners (e.g., with one node designated as the primary node and the other designated as the secondary), in alternative examples any other node within a cluster may be allowed to step in after a failure of a given node without defining HA pairs.

As discussed above, one or more volumes (e.g., volumes 630a-m and volumes 630n-x) or LUNs (not shown) may be created by or on behalf of customers for hosting/storing their enterprise application data within respective DEFSs (e.g., data DEFSs 620a and 620b).

While additional data structures may be employed, in this example, each DEFS is shown being associated with respective AA maps (indexed by AA ID) and active maps (indexed by PVBN). For example, log DEFS 625a may utilize AA map 627a to track those of the AAs within a global PVBN space 640 of storage pod 645 (which may be analogous to storage pod 145) that are owned by log DEFS 625a and may utilize active map 626a to track at a PVBN level of granularity which of the PVBNs of its AAs are in use; log DEFS 625b may utilize AA map 627b to track those of the AAs within the global PVBN space 640 that are owned by log DEFS 625b and may utilize active map 626b to track at a PVBN level of granularity which of the PVBNs of its AAs are in use; data DEFS 620a may utilize AA map 622a to track those of the AAs within the global PVBN space 640 that are owned by data DEFS 620a and may utilize active map 621a to track at a PVBN level of granularity which of the PVBNs of its AAs are in use; and data DEFS 620b may utilize AA map 622b to track those of the AAs within the global PVBN space 640 that are owned by data DEFS 620b and may utilize active map 621b to track at a PVBN level of granularity which of the PVBNs of its AAs are in use.

In this example, each DEFS of a given node has visibility and accessibility into the entire global PVBN address space 640 and any AA (except for a predefined super block AA 642) within the global PVBN address space 640 may be assigned to any DEFS within the cluster. By extension, each node has visibility and accessibility into the entire global PVBN address space 640 via its DEFSs. As noted above, the respective AA maps of the DEFSs define which PVBNs to which the DEFSs have exclusive write access. AAs within the global PVBN space 640 shaded in light gray, such as AA 641a, can only be written to by node 610a as a result of their ownership by or assignment to data DEFS 620a. Similarly AAs within the global PVBN space 640 shaded in dark gray, such as AA 641b, can only be written to by node 610b as a result of their ownership by or assignment to data DEFS 620b.

Returning to super block 642, it is part of a super block AA (or super AA). In the context of FIG. 13A, the super AA is the first AA of the storage pod 645. The super AA is not assigned to any DEFS (as indicated by its lack of shading). The super AA may have an array of DEFS areas which are dedicated to each DEFS and can be indexed by a DEFS ID. The DEFS ID may start at index 1 and in the context of the present example includes four super block and four DEFS label blocks. The DEFS label can act as a RAID label for the DEFS and can be written out of a CP and can store information that needs to be kept outside of the file system. In a pairwise HA configuration, two super blocks and two DEFS label blocks may be used by the hosting node and the other two may be used by the partner node on takeover. Each of these special blocks may have their own separate stripes.

In the context of the present example, it is assumed after establishment of the disaggregated storage within the storage pod 645 and after the original assignment of ownership of AAs to data DEFS 620a and data DEFS 620b, some AAs have been transferred from data DEFS 620a to data DEFS 620b and/or some AAs have been transferred from data DEFS 620b to data DEFS 620a. As such, the different shades of grayscale of entries within the AA maps are intended to represent potential caching that may be performed regarding ownership of AAs owned by other DEFSs in the cluster. For example, assuming ownership of a partial AA has been transferred from data DEFS 620a to data DEFS 620b as part of an ownership change performed in support of space balancing, when data DEFS 620a would like to free a given PVBN (e.g., when the given PVBN is no longer referenced by data DEFS 620a as a result of data deletion or otherwise), data DEFS 620a should send a request to free the PVBN to the new owner (in this case, data DEFS 620b). This is due to the fact that in various embodiments, only the current owner of a particular AA is allowed to perform any modify operations on the particular AA.

Those skilled in the art will appreciate disaggregation of the storage space as discussed herein can be leveraged for cost-effective scaling of infrastructure. For example, the disaggregated storage allows more applications to share the same underlying storage infrastructure. Given that each DEFS represents an independent file system, the use of multiple of such DEFSs combine to create a cluster-wide distributed file system since all of the DEFSs within a cluster share a global PVBN space (e.g., global PVBN space 640). This provides the unique ability to independently scale each independent DEFS as well as enables fault isolation and repair in a manner different from existing distributed file systems.

Additional aspects of FIG. 13A will now be described in connection with a discussion of FIG. 13B, which represents a high-level flow diagram illustrating operations for establishing disaggregated storage within a storage pod (e.g., storage pod 645). The processing described with reference to FIG. 13B, may be performed by a combination of a file system (e.g., file system 1060) and a RAID system (e.g., RAID system 380), for example, during or after an initial boot up.

At block 661, the storage pod is created based on a set of storage devices (or disks) made available for use by the cluster. For example, job may be executed by a management plane of the cluster to create the storage pod and assign the disks to the cluster. Depending on the particular implementation and the deployment environment (e.g., on-prem versus cloud), the disks may be associated with of one or more disk arrays or one or more storage shelves or persistent storage in the form of cloud volumes provided by a cloud provider from a pool of storage devices within a cloud environment. For simplicity, cloud volumes may also be referred to herein as “disks.” The disks may be HDDs or SSDs.

At block 662, the storage space of the set of disks may be divided or partitioned into uniform-sized AAs. The set of disks may be grouped to form multiple RAID groups (e.g., RAID group 650a and 650b) depending on the RAID level (e.g., RAID 4, RAID 5, or other). Multiple RAID stripes may then be grouped to form individual AAs. As noted above, an AA (e.g., AA 641a or AA 641b) may be a large chunk representing one or more GB of storage space and preferably accommodates multiple SSD erase blocks work of data. In one embodiment, the size of the AAs is tuned for the particular file system. The size of the AAs may also take into consideration a desire to reduce the need for performing space balancing so as to minimize the need for internode (e.g., East-West) communications/traffic. In some examples, the size of the AAs may be between about 1 GB to 10 GB. As can be seen in FIG. 13A, dividing the storage pod 645 into AAs allows available storage space associated with any given disk or any RAID group to be use across many/all nodes in the cluster without creating silos of space in each node. For example, at the granularity of an individual AA, available storage space within the storage pod 645 may be assigned to any given node in the cluster (e.g., by way of the given node's DEFS(s)). For example, in the context of FIG. 13A, AA 641a and the other AAs shaded in light gray are currently assigned to (or owned by) data DEFS 620a (which has a corresponding light gray shading). Similarly, AA 641b and the other AAs shaded in dark gray are currently assigned to (or owned by) data DEFS 620b (which has a corresponding light gray shading).

At block 663, ownership of the AAs is assigned to the DEFSs of the nodes of the cluster. According to one embodiment, an effort may be made to assign group of consecutive AAs to each DEFS. Initially, the distribution of storage space represented by the AAs assigned to each type of DEFS (e.g., data versus log) may be equal or roughly equal. Over time, based on differences in storage consumption by associated workloads, for example, due to differing write patterns, ownership of AAs may be transferred among the DEFSs accordingly.

As a result, of creating and distributing the disaggregated storage across a cluster in this manner, all disks and all RAID groups can theoretically to be accessed concurrently by all nodes and the issue discussed with reference to FIG. 12 in which the entirety of any given disk and the entirety of any given RAID group is owned by a single node is avoided.

### Example of Remote Free Block Logs Among Dynamically Extensible File Systems

In a disaggregated storage architecture, every DEFS, which is analogous to a Flexible Aggregate, has access to an entire storage pod. In other words, every DEFS can access an entire PVBN space available in the storage pod. As previously discussed, the disaggregated storage architecture allows AA movement for space balancing and features like zero-copy volume movement. Upon these features being available, it is possible and likely that container files on each DEFS are found using PVBNs out of AAs that the DEFS does not own at that point in time. There are several use cases like scanners, file system consistency checks, etc. where a file system scanner or subsystem running in a context of a given DEFS might have to access regions of aggregate bitmap metafiles (e.g., active map/cde map/reference count file/claim map/reference count file) or container files for PVBNs that are in the AAs that the DEFS does not currently own. In the local copy of these aggregate bitmap metafiles, the regions corresponding to PVBNs residing in AAs that the DEFS does not own will be VBN holes. A local DEFS that does not own an AA having PVBNs to be freed will not be able to update metadata files to free the PVBNs. To address this issue, remote free logs are being added to each DEFS to temporarily store the PVBNs to be freed and transfer the PVBNs to a remote DEFS that owns the AA having the PVBNs to be freed. The DEFS owning the AA can update metadata files for PVBNs to be freed.

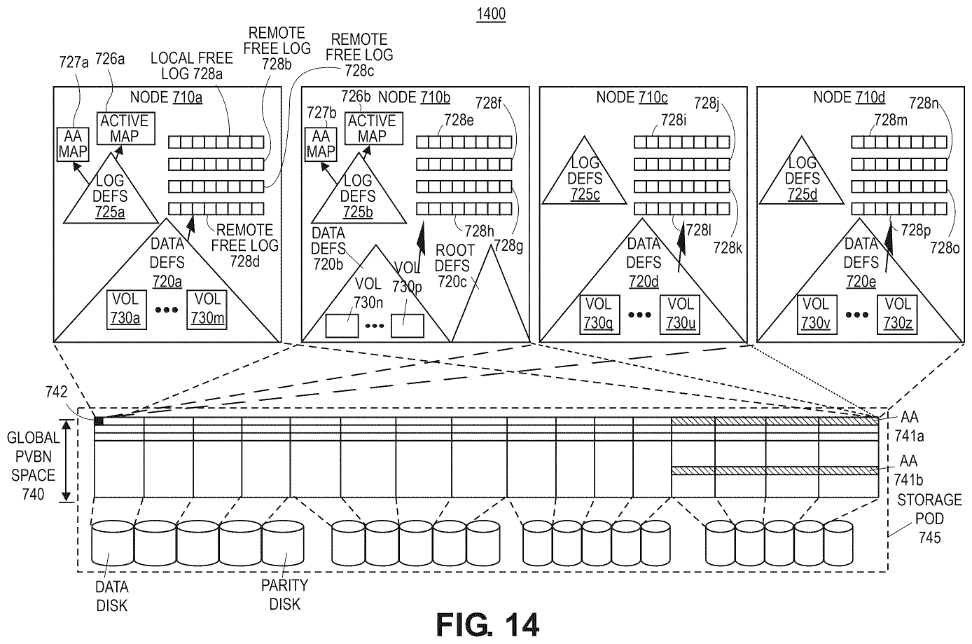

FIG. 14 is a block diagram illustrating a distributed storage system architecture 1400 that provides disaggregated storage and remote free block logs for each DEFS in accordance with an embodiment of the present disclosure. Various architectural advantages of the proposed distributed storage system architecture and mechanisms for providing and making use of disaggregated storage include, but are not limited to, the ability to batch freed blocks in remote free logs from a local node to a remote node owning the freed blocks, perform automatic space balancing among DEFSs, perform elastic node growth and shrinkage for a cluster, perform elastic storage growth of the storage pod, perform zero-copy file and volume move (migration), perform distributed RAID rebuild, achieve HA cost reduction using volume rehosting, create remote clones, and perform global data deduplication.

In the context of the present example, the nodes (e.g., node 710a, 710b, 710c, 710d, etc.) of a cluster, which may represent a data pod or include multiple data pods, each include respective data dynamically extensible file systems (DEFSs) (e.g., data DEFS 720a, data DEFS 720b, data DEFS 720d, data DEFS 720e, etc.) and respective log DEFSs (e.g., log DEFS 725a, log DEFS 725b, log DEFS 725c, log DEFS 725d, etc.). In general, data DEFSs (or analogous to flexible aggregate 720a, flexible aggregate 720b, flexible aggregate 720d, flexible aggregate 720e) may be used for persisting data on behalf of clients (e.g., client 180), whereas log DEFSs may be used to maintain an operation log or journal of certain storage operations within the journaling storage media that have been performed since the last CP. The data DEFS 720a may also include a local free log 728a to temporarily store blocks (e.g., PVBNs) to be freed that are located in an AA owned by DEFS 720a, a remote free log 728b to temporarily store blocks (e.g., PVBNs) to be freed that are located in an AA owned by DEFS 720b, a remote free log 728c to temporarily store blocks (e.g., PVBNs) to be freed that are located in an AA owned by DEFS 720d, and a remote free log 728d to temporarily store blocks (e.g., PVBNs) to be freed that are located in an AA owned by DEFS 720e. In a similar manner, the data DEFS 720b includes a local free log 628e, a remote free log 628f, a remote free log 628g, and a remote free log 628h. The data DEFS 720d includes a local free log 628i, a remote free log 628j, a remote free log 628k, and a remote free log 628l. The data DEFS 720e includes a local free log 628m, a remote free log 628n, a remote free log 628o, and a remote free log 628p. Any of the nodes can include a root DEFS such as root DEFS 720c.

It should be noted that while for simplicity only four nodes, which may be configured as part of an HA pair for fault tolerance and nondisruptive operations, are shown in the illustrative cluster depicted in FIG. 14, there may be one or more additional nodes in a given cluster. For example, there may be multiple HA pairs within a cluster (or a data pod of the cluster, which may represent a mechanism to limit the fault domain). As such, the description of this four-node cluster should be taken as illustrative only. Furthermore, while in some examples HA may be achieved by defining pairs of nodes within a cluster as HA partners (e.g., with one node designated as the primary node and the other designated as the secondary), in alternative examples any other node within a cluster may be allowed to step in after a failure of a given node without defining HA pairs.

As discussed above, one or more volumes (e.g., volumes 730a-m, volumes 730n-p, volumes 730q-730u, 730v-730z, etc.) or LUNs (not shown) may be created by or on behalf of customers for hosting/storing their enterprise application data within respective DEFSs.

While additional data structures may be employed, in this example, some DEFSs are shown being associated with respective AA maps (indexed by AA ID) and active maps (indexed by PVBN) although all DEFSs can have AA maps and active maps. For example, data DEFS 720a may utilize AA map 727a to track those of the AAs within a global PVBN space 740 of storage pod 745 (which may be analogous to storage pod 145) that are owned by data DEFS 720a and may utilize active map 726a to track at a PVBN level of granularity which of the PVBNs of its AAs are in use; data DEFS 720b may utilize AA map 727b to track those of the AAs within the global PVBN space 740 that are owned by data DEFS 720b and may utilize active map 726b to track at a PVBN level of granularity which of the PVBNs of its AAs are in use; data DEFS 720d may utilize an AA map to track those of the AAs within the global PVBN space 740 that are owned by data DEFS 720d and may utilize an active map to track at a PVBN level of granularity which of the PVBNs of its AAs are in use; and data DEFS 720e may utilize an AA map to track those of the AAs within the global PVBN space 740 that are owned by data DEFS 720e and may utilize the active map to track at a PVBN level of granularity which of the PVBNs of its AAs are in use.

In this example, each DEFS of a given node has visibility and accessibility into the entire global PVBN address space 740 and any AA (except for a predefined super block AA 742) within the global PVBN address space 740 may be assigned to any DEFS within the cluster. By extension, each node has visibility and accessibility into the entire global PVBN address space 740 via its DEFSs. As noted above, the respective AA maps of the DEFSs define which PVBNs to which the DEFSs have exclusive write access. AAs within the global PVBN space 740 shaded in light gray, such as AA 741a, can only be written to by node 710a as a result of their ownership by or assignment to data DEFS 720a. Similarly AAs within the global PVBN space 740 shaded in light gray, such as AA 741b, can only be written to by node 710b as a result of their ownership by or assignment to data DEFS 720b.

Returning to super block 742, it is part of a super block AA (or super AA). In the context of FIG. 13A, the super AA is the first AA of the storage pod 745. The super AA is not assigned to any DEFS (as indicated by its lack of shading). The super AA may have an array of DEFS areas which are dedicated to each DEFS and can be indexed by a DEFS ID. The DEFS ID may start at index 1. The DEFS label can act as a RAID label for the DEFS and can be written out of a CP and can store information that needs to be kept outside of the file system. In a pairwise HA configuration, two super blocks and two DEFS label blocks may be used by the hosting node and the other two may be used by the partner node on takeover. Each of these special blocks may have their own separate stripes.

In the context of the present example, it is assumed after establishment of the disaggregated storage within the storage pod 745 and after the original assignment of ownership of AAs to data DEFS 720a, data DEFS 720b, data DEFS 720d, and data DEFS 720e, some AAs have been transferred from data DEFS 720a to data DEFS 720b, data DEFS 720d, or data DEFS 720e, and/or some AAs have been transferred from data DEFS 720b to data DEFS 720a, data DEFS 720d, or data DEFS 720e. For example, assuming ownership of a partial AA has been transferred from data DEFS 720a to data DEFS 720b as part of an ownership change performed in support of space balancing, when data DEFS 720a would like to free a given PVBN (e.g., when the given PVBN is no longer referenced by data DEFS 720a as a result of data deletion or otherwise), data DEFS 720a should send a request to free the PVBN to the new owner (in this case, data DEFS 720b). This is due to the fact that in various embodiments, only the current owner of a particular AA is allowed to perform any modify operations on the particular AA.

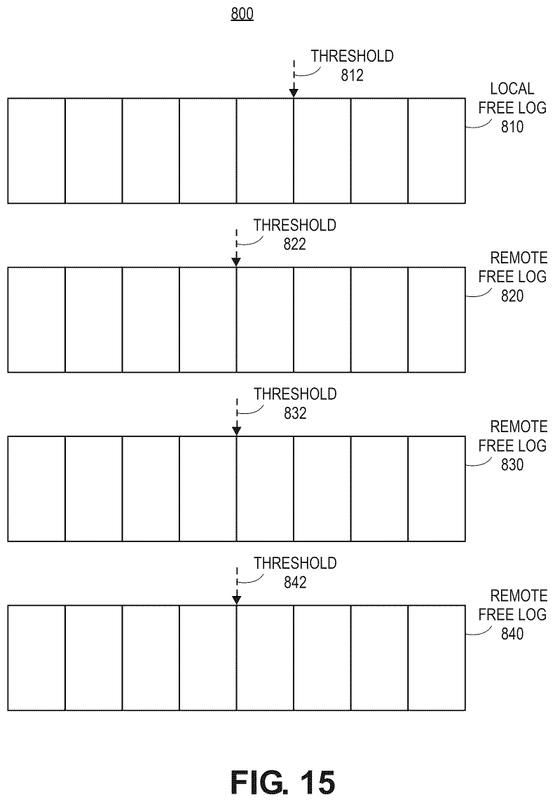

FIG. 15 is a diagram showing a local free log and remote free logs for temporarily storing blocks (e.g., PVBNs) to be freed in accordance with an embodiment of the present disclosure. A local node (e.g., node 710a, 710b, 710c, 710d) includes a local free log 810, a remote free log 820, a remote free log 830, and a remote free log 840. Blocks (e.g., PVBNs) to be freed of an AA owned by a local DEFS of a local node are temporarily transferred to the local free log. Once the PVBNs in the log reaches an optional threshold 812, then these PVBNs are processed to be freed (not in use) with associated metadata files being updated. These metadata files may include blocks starting from fs info block to specify the layout of information in the file system and include an inode of a file that includes all other inodes of the file system, inofile indirect, inofile L0, metafile indirect, metafile L0, etc. For example, storage systems can maintain metadata indicating which data blocks are available to be allocated, which data blocks belong to particular storage objects, etc. While some of the metadata remains relatively static, other metadata is subject to frequent modification. The metadata can be represented by an active map and a reference count map. In one example, the active map is a bitmap in which each bit corresponds to a particular block. If the bit is set to a first logic state (e.g., ‘0’, ‘1’) the block is free; if the bit is set to a second logic state (e.g., ‘1’, ‘0’) the block is allocated. The reference count map can have groups of bits corresponding to individual blocks and store the count of references associated with each respective block.

Blocks (e.g., PVBNs) to be freed of an AA not owned by a local DEFS of a local node are temporarily transferred to one of the remote free logs 820, 830, 840. Once the PVBNs in a remote free log reach an optional threshold (e.g., threshold 822, 832, 842), then these PVBNs are transferred to a corresponding remote DEFS that does own the AA and associated PVBNs to be freed (not in use).

If a PVBN is initially part of an AA owned by a local DEFS, then the PVBN is temporarily stored in the local free log. However, if it is subsequently determined that the AA has been moved to a remote DEFS, then the PBVN can be moved to a remote free log for the remote DEFS.

The threshold level can be preconfigured, determined dynamically, or a combination thereof. For example, the threshold level in the remote free log might be a percentage (e.g., 1-2%) of blocks being freed. In another example, the threshold level relates to a percentage of available space on one or more storage devices. The particular percentage might be preconfigured while the actual threshold is dynamically determined by determining the amount of available space and multiplying the amount of available space by the particular percentage. A block free unit can then compare the threshold with the size of the active log. The remote DEFS that receives the batched messages from the local DEFS can then truncate the blocks to be freed and reclaim the free blocks for future usage.

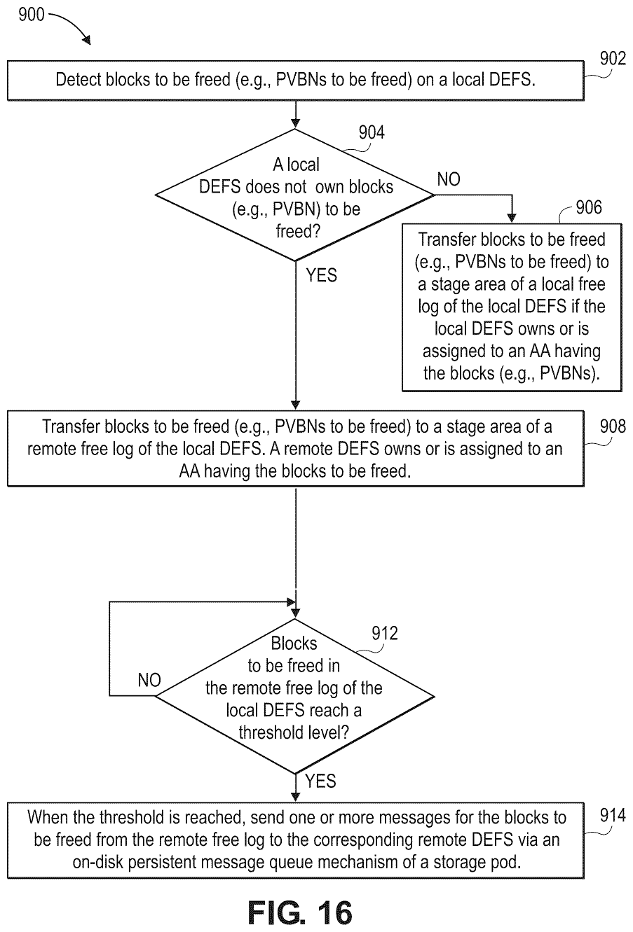

FIG. 16 is a flow diagram of a computer-implemented method 900 illustrating operations for temporarily storing blocks (e.g., PVBNs to be freed) to be freed in remote free logs and then transferring the blocks (e.g., PVBNs to be freed) from a local DEFS to a corresponding remote DEFS that owns an AA associated with the blocks in accordance with an embodiment of the present disclosure. The processing described with reference to FIG. 16 may be performed by a storage system (e.g., node 110a, 110b, 610a, 610b, 710a, 710b, 710c, 710d, etc.) of a distributed storage system (e.g., cluster 800 or a cluster including nodes 610a, 610b, or a cluster including nodes 710a, 710b, 710c, 710d, or possibly one or more other nodes). The operations of computer-implemented method 900 may be executed by one or more processing resources, a storage controller, a storage virtual machine, a multi-site distributed storage system having an OS, a storage node, a computer system, a machine, a server, a web appliance, a centralized system, a distributed node, or any system, which includes processing logic (e.g., one or more processors, a processing resource). The processing logic may include hardware (circuitry, dedicated logic, etc.), software (such as is run on a general purpose computer system or a dedicated machine or a device), or a combination of both.

At operation 902, the computer-implemented method includes detecting blocks to be freed (e.g., PVBNs to be freed) on a local DEFS. For example, a command might indicate that data should be “deleted” instead of explicitly stating that a block should be freed. As another example, a command can be a file-level command instead of a block-level command. A file-level command might specify that a particular file should be deleted. At operation 904, the method includes determining when a local DEFS does not own an allocation area (AA) having one or more blocks (e.g., PVBNs) to be freed (or determines an owner of an AA having the PVBNs).

At operation 906, the method transfers blocks to be freed (e.g., PVBNs to be freed) to a stage area of a local free log of the local DEFS if the local DEFS owns or is assigned to the AA that is associated with the blocks (e.g., PVBNs). Space deallocation (also called “hole punching” and “unmap”) can be enabled for namespaces (e.g., NVMe namespaces) by default. Space deallocation allows a host to deallocate unused blocks to be freed (e.g., PVBNs to be freed) from namespaces to reclaim space. This greatly improves overall storage efficiency, especially with filesystems that have data high turnover. The PBVNs to be free in the local free log are processed for space deallocation by the local DEFS.

At operation 908, the method transfers blocks to be freed (e.g., PVBNs to be freed) to a stage area of a remote free log of the local DEFS when a remote DEFS owns or is assigned to an AA having the blocks to be freed. At operation 912, the method includes determining when blocks to be freed in the remote free log of the local DEFS reach a threshold level, and then at operation 914, when the threshold is reached, batch sending one or more messages for the blocks to be freed from the remote free block log to the corresponding remote DEFS via an on-disk (on-storage device) persistent message queue mechanism of a storage pod.

Embodiments of the present disclosure include various steps, which have been described above. The steps may be performed by hardware components or may be embodied in machine-executable instructions, which may be used to cause one or more processing resources (e.g., one or more general-purpose or special-purpose processors) programmed with the instructions to perform the steps. Alternatively, depending upon the particular implementation, various steps may be performed by a combination of hardware, software, firmware and/or by human operators.

Embodiments of the present disclosure may be provided as a computer program product, which may include a non-transitory machine-readable storage medium embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more non-transitory machine-readable storage media containing the code according to embodiments of the present disclosure with appropriate special purpose or standard computer hardware to execute the code contained therein. An apparatus for practicing various embodiments of the present disclosure may involve one or more computers (e.g., physical and/or virtual servers) (or one or more processors (e.g., processors 222a-b) within a single computer) and storage systems containing or having network access to computer program(s) coded in accordance with various methods described herein, and the method steps associated with embodiments of the present disclosure may be accomplished by modules, routines, subroutines, or subparts of a computer program product.

The term “storage media” as used herein refers to any non-transitory media that store data or instructions that cause a machine to operation in a specific fashion. Such storage media may comprise non-volatile media or volatile media. Non-volatile media includes, for example, optical, magnetic or flash disks, such as storage device (e.g., local storage 930). Volatile media includes dynamic memory, such as main memory (e.g., memory 224). Common forms of storage media include, for example, a flexible disk, a hard disk, a solid state drive, a magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus (e.g., system bus 923). Transmission media can also take the form of acoustic or light waves, such as those generated during radio-wave and infra-red data communications.

Various forms of media may be involved in carrying one or more sequences of one or more instructions to the one or more processors for execution. For example, the instructions may initially be carried on a magnetic disk or solid state drive of a remote computer. The remote computer can load the instructions into its dynamic memory and send the instructions over a telephone line using a modem. A modem local to the computer system can receive the data on the telephone line and use an infra-red transmitter to convert the data to an infra-red signal. An infra-red detector can receive the data carried in the infra-red signal and appropriate circuitry can place the data on bus. Bus carries the data to main memory (e.g., memory 224), from which the one or more processors retrieve and execute the instructions. The instructions received by main memory may optionally be stored on storage device either before or after execution by the one or more processors.

All examples and illustrative references are non-limiting and should not be used to limit the applicability of the proposed approach to specific implementations and examples described herein and their equivalents. For simplicity, reference numbers may be repeated between various examples. This repetition is for clarity only and does not dictate a relationship between the respective examples. Finally, in view of this disclosure, particular features described in relation to one aspect or example may be applied to other disclosed aspects or examples of the disclosure, even though not specifically shown in the drawings or described in the text.

The foregoing outlines features of several examples so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the examples introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A computer-implemented method comprising:
detecting, with a first dynamically extensible file system (DEFS) of a first storage node or of a second storage node of a storage cluster having a disaggregated storage space within a storage pod, physical volume block numbers (PVBNs) to be freed;
determining whether the first DEFS owns or does not own a first allocation area (AA) having the PVBNs to be freed;
transferring non-owned PVBNs to be freed to a remote free log of the first DEFS when the first AA having the PVBNs to be freed is not owned or assigned to the first DEFS;
determining when PVBNs in the remote free log reach a threshold level; and
batch sending two or more messages for the PVBNs to be freed from the remote free log of the first DEFS to a remote second DEFS based on the remote free log reaching the threshold level.

2. The computer-implemented method of claim 1, wherein when the threshold is reached, sending the two or more batched messages for the PVBNs to be freed from the remote free block log to the second DEFS via an on-disk persistent message queue mechanism of the storage pod.

3. The computer-implemented method of claim 1, wherein the threshold level is preconfigured, determined dynamically, or a combination thereof.

4. The computer-implemented method of claim 1, wherein the threshold level in the remote free log is a percentage of blocks being freed.

5. The computer-implemented method of claim 1, wherein the threshold level relates to a percentage of available space on one or more storage devices.

6. The computer-implemented method of claim 1, wherein a percentage of available space on one or more storage devices is preconfigured and the threshold level is dynamically determined by determining an amount of available space and multiplying the amount of available space by the preconfigured percentage.

7. The computer-implemented method of claim 1, further comprising:
comparing the threshold level with a size of the remote free log.

8. A non-transitory machine readable medium storing instructions, which when executed by one or more processing resources of a distributed storage system, cause the distributed storage system to:
detect, with a first dynamically extensible file system (DEFS) of a first storage node or of a second storage node of a storage cluster having a disaggregated storage space within a storage pod, physical volume block numbers (PVBNs) to be freed;
determine whether the first DEFS owns or does not own a first allocation area (AA) having the PVBNs to be freed;
transfer non-owned PVBNs to be freed to a remote free log of the first DEFS when the first AA having the PVBNs to be freed is not owned or assigned to the first DEFS;
determine when PVBNs in the remote free log reach a threshold level; and
batch sending two or more messages for the PVBNs to be freed from the remote free log of the first DEFS to a remote second DEFS based on the remote free log reaching the threshold level.

9. The non-transitory machine readable medium of claim 8, wherein when the threshold is reached, sending the two or more batched messages for the PVBNs to be freed from the remote free block log to the second DEFS via an on-disk persistent message queue mechanism of a storage pod.

10. The non-transitory machine readable medium of claim 8, wherein the threshold level is preconfigured, determined dynamically, or a combination thereof.

11. The non-transitory machine readable medium of claim 8, wherein the threshold level in the remote free log is a percentage of blocks being freed.

12. The non-transitory machine readable medium of claim 8, wherein the threshold level relates to a percentage of available space on one or more storage devices.

13. The non-transitory machine readable medium of claim 8, wherein a percentage of available space on one or more storage devices is preconfigured and the threshold level is dynamically determined by determining an amount of available space and multiplying the amount of available space by the preconfigured percentage.

14. The non-transitory machine readable medium of claim 8, further comprising:
receiving a command to indicate that data of a PVBN to be freed should be deleted.

15. A distributed storage system comprising:
one or more processing resources; and
instructions that when executed by the one or more processing resources cause the distributed storage system to:
detect, with a first dynamically extensible file system (DEFS) of a first storage node or of a second storage node of a storage cluster having a disaggregated storage space within a storage pod, physical volume block numbers (PVBNs) to be freed;
determine whether the first DEFS owns or does not own a first allocation area (AA) having the PVBNs to be freed;
transfer non-owned PVBNs to be freed to a remote free log of the first DEFS when the first AA having the PVBNs to be freed is not owned or assigned to the first DEFS;
determine when PVBNs in the remote free log reach a threshold level; and
batch sending two or more messages for the PVBNs to be freed from the remote free log of the first DEFS to a remote second DEFS based on the remote free log reaching the threshold level.

16. The distributed storage system of claim 15, wherein when the threshold is reached, sending the two or more batched messages for the PVBNs to be freed from the remote free block log to the second DEFS via an on-disk persistent message queue mechanism of a storage pod.

17. The distributed storage system of claim 15, wherein the threshold level is preconfigured, determined dynamically, or a combination thereof.

18. The distributed storage system of claim 15, wherein the threshold level in the remote free log is a percentage of blocks being freed.

19. The distributed storage system of claim 15, wherein the threshold level relates to a percentage of available space on one or more storage devices.

20. The distributed storage system of claim 15, wherein a percentage of available space on one or more storage devices is preconfigured and the threshold level is dynamically determined by determining an amount of available space and multiplying the amount of available space by the preconfigured percentage.
